(19) United States
(12) Patent Application Publication
(10) Pub. No.: US 2024/0174946 A1
(43) Pub. Date: May 30, 2024

(54) DETERGENT COMPOSITION FOR USE IN AUTOMATIC DISHWASHER

(71) Applicant: Kao Corporation, Tokyo (JP)

(72) Inventors: Takuji KAWAMURA, Wakayama-shi (JP); Kenji HOZUMI, Wakayama-shi (JP)

(73) Assignee: Kao Corporation, Tokyo (JP)

(21) Appl. No.: 18/551,525

(22) PCT Filed: Mar. 28, 2022
(86) PCT No.: PCT/JP2022/014767

§ 371 Date: Sep. 20, 2023

(30) Foreign Application Priority Data
Mar. 31, 2021 (JP) 2021-059927
Mar. 31, 2021 (JP) 2021-059928
Mar. 31, 2021 (JP) 2021-059929
Mar. 31, 2021 (JP) 2021-059930

(51) Int. Cl. C11D 1/12; C11D 1/66; C11D 3/04; C11D 3/12; C11D 3/26; C11D 3/36; C11D 3/37

(52) U.S. Cl. CPC C11D 1/12; C11D 1/66; C11D 3/046; C11D 3/122; C11D 3/26; C11D 3/36; C11D 3/37; C11D 2111/14; C11D 2111/40

(57) ABSTRACT

A detergent composition, containing the following component (a), the following component (c1), and water: component (a): a reducing agent with an oxidation-reduction potential of +71 mV or less, and component (c1): a low-foaming anionic surfactant. The composition has a content of the component (a) of 3 mass % or more, a content of water of 20 mass % or more, and a pH of 6 or more and 11 or less at 25° C.

### FIELD OF THE INVENTION

The present invention relates to a detergent composition for use in an automatic dishwasher, a method for washing tableware and a method for washing a hard surface.

### BACKGROUND OF THE INVENTION

Dishwashers are used for washing tableware such as dirty dishes, glasses, cooking utensils or the like in kitchens of households, restaurants, coffee shops or the like and for washing plastic containers for foodstuffs and products used in food and beverage manufacturing plants. Main target soils are protein, starch, oils and fats or the like derived from food, and these soils combine together to adhere to tableware such as dishes, glasses, cooking utensils or the like or plastic containers. Further, in some cases, these soils are heat-denatured during heating cooking to be stubborn soil and stick thereto.

Washing with a dishwasher is usually carried out in the order of a washing process and a rinsing process. The time required for these processes is very short in a business use, and about 40 to 180 seconds for a washing process and about 5 to 20 seconds for a rinsing process in process design. However, in the case of stubborn soil, such a designed time may result in insufficient washing, and it is not uncommon for a washing process to take several times longer than designed to achieve sufficient washing.

JP-A H5-255693 discloses a detergent composition containing a salt of an anionic surfactant with a basic amino acid and containing from 0.005 to 10% by weight of a water-soluble reducing agent and/or from 0.005 to 10% by weight of a chelating agent, thereby being not so stimulative to the skin and mucous membrane and free from the offensive odor of the basic amino acid therein.

JP-A H9-78099 discloses a granular detergent composition with a high bulk density containing 3.1 to 10 weight % of a sulfite, 1 to 30 weight % of a nonionic surfactant and 0.01 weight % or more of a fragrance and having a bulk density of 0.6 g/ml or more, thereby achieving good stability of an aroma of the fragrance even after a long period of time has passed.

JP-A 2015-199941 discloses a liquid detergent composition containing a specific sulfosuccinic acid alkyl ester (A) and protease (B), thereby being able to wash stains on tableware or cooking utensils without applying large mechanical force.

JP-A 2002-146394 discloses a cleaning agent for home use not damaging a material and showing excellent cleaning power and persistence particularly when used for washing plain wood, wherein the agent is an aqueous solution containing sodium sulfite and a surfactant as essential components and having a pH adjusted to fall within the range of 5 to 8.

JP-A 2016-522279 discloses a liquid detergent composition containing, a) an alkanolamine, b) a sulfite, c) a perfume oil containing aldehyde or ketone and d) a sulfur-containing pro-perfume compound, wherein the composition delivers improved stability and perfume longevity.

JP-A 2002-3899 discloses an anti-choking agent for use in a detergent, the anti-choking agent being contained in a solid or powdery detergent which contains a chelating agent or the like as a main component for washing, and contains a carbonate and/or a percarbonate and an organic acid including at least one of succinic acid, fumaric acid, citric acid and malic acid and generates carbon dioxide gas when used by bringing it into contact with water or the like, wherein the anti-choking agent contains a surfactant which generates foam during use as an active component, and a detergent composition containing the anti-choking agent.

JP-A S62-265398 discloses a method for removing proteinaceous stains from a fabric including, treating the fabric with a wash liquid containing an effective amount of protease and an effective amount of a reagent capable of cleaving disulfide bonds (a disulfide cleavage reagent, DCR).

JP-A H2-168226 discloses a method for cleaning a contact lens including, immersing and heating a dirty contact lens in a cleaning liquid containing a thiocyanate and a reducing agent, thereby cleaning the contact lens.

JP-A 2002-256294 discloses a method for cleaning a dirty surface of an object to be cleaned where dirty substances such as hair, skin waste products or the like are present with a cleaning agent composition containing keratinases, which are one kind of proteases, and a non-sulfur-based reducing agent, especially a phosphorous reducing agent, which reduces and cleaves S—S bonds in keratin constituting hair.

### SUMMARY OF THE INVENTION

While there are various kinds of soil adhering to a hard surface, particularly tableware, above all, soil containing protein is soil that is more likely to be altered and solidified and less likely to be removed by short-time washing with a dishwasher for business use. Particularly, egg yolk or the like causes stubborn sticking of soil depending on the state of alteration of soil which has been dried, denatured or the like over time after soil adhesion, making short-time washing more difficult. In order to achieve effective washing of soil containing protein by short-time washing, washing under a strong alkalinity condition is unavoidable at present, but in view of effects on workers or the environment, it is desirable that washing be carried out in the liquid property region of neutrality to weak alkalinity.

Further, in dishwashers for business use where a washing liquid used for washing tableware is usually reused, the washing liquid is mixed with soil or diluted with rinsing water to have a liquid property in the region of neutrality to weak alkalinity, and in such a case, the problem is that soil containing protein is less likely to be removed.

The present invention provides a detergent composition for use in an automatic dishwasher, a method for washing tableware and a method for washing a hard surface that can achieve effective washing of soil containing protein.

The present invention relates to a detergent composition for use in an automatic dishwasher containing the following component (a), the following component (c1) and water,
component (a): a reducing agent with an oxidation-reduction potential of +71 mV or less, and
component (c1): a low-foaming anionic surfactant,
wherein the composition has a pH of 6 or more and 11 or less at 25° C.

The above detergent composition for use in an automatic dishwasher is hereinafter referred to as a first detergent composition for use in an automatic dishwasher of the present invention.

Further, the present invention relates to a method for washing tableware including, washing, by using an automatic dishwasher, tableware adhered with soil containing protein with a washing liquid prepared by diluting the first detergent composition for use in an automatic dishwasher of the present invention with water.

The above method for washing tableware is hereinafter referred to as a first method for washing tableware of the present invention.

Further, the present invention relates to a detergent composition for use in an automatic dishwasher containing the following component (b1), the following component (a) and water,
component (b1): a chelating agent with a conditional calcium stability constant pK′Ca of 3.2 or more at a pH of 7.5 and 60° ° C., and
component (a): a reducing agent with an oxidation-reduction potential of +71 mV or less,
wherein a content of component (a) is more than 0.5 mass % and 30 mass % or less, and the composition has a pH of 6 or more and 11 or less at 25° C.

The above detergent composition for use in an automatic dishwasher is hereinafter referred to as a second detergent composition for use in an automatic dishwasher of the present invention.

Further, the present invention relates to a method for washing tableware including, washing, by using an automatic dishwasher, tableware adhered with soil containing protein with a washing liquid prepared by diluting the second detergent composition for use in an automatic dishwasher of the present invention with water.

The above method for washing tableware is hereinafter referred to as a second method for washing tableware of the present invention.

Further, the present invention relates to a detergent composition for use in an automatic dishwasher containing the following component (a), the following component (e) and water,
component (a): a reducing agent with an oxidation-reduction potential of +71 mV or less, and
component (e): a hydroxide of an alkali metal, wherein the composition has a pH of more than 11 and 14 or less at 25° C.

The above detergent composition for use in an automatic dishwasher is hereinafter referred to as a third detergent composition for use in an automatic dishwasher of the present invention.

Further, the present invention relates to a method for washing tableware including, washing, by using an automatic dishwasher, tableware adhered with soil containing protein with a washing liquid prepared by diluting the third detergent composition for use in an automatic dishwasher of the present invention with water.

The above method for washing tableware is hereinafter referred to as a third method for washing tableware of the present invention.

Further, the present invention relates to a method for washing a hard surface including, bringing a washing liquid at a pH of 6 or more and 11 or less into contact with a hard surface adhered with soil containing protein such that a cleavage rate of disulfide bonds in protein molecules or between proteins is 20% or more and 100% or less.

The above method for washing a hard surface is hereinafter referred to as a fourth method for washing a hard surface of the present invention.

According to the first detergent composition for use in an automatic dishwasher and the first method for washing tableware of the present invention, provided are a detergent composition for use in an automatic dishwasher and a method for washing tableware that can achieve effective washing of soil containing protein by washing with a dishwasher even if a liquid property is in the region of neutrality to weak alkalinity.

According to the second detergent composition for use in an automatic dishwasher and the second method for washing tableware of the present invention, provided are a detergent composition for use in an automatic dishwasher and a method for washing tableware that can achieve effective washing of soil containing protein by washing with a dishwasher even if a liquid property is in the region of neutrality to weak alkalinity.

According to the third detergent composition for use in a dishwasher and the third method for washing tableware of the present invention, provided are a detergent composition for use in a dishwasher and a method for washing tableware that can achieve effective washing of soil containing protein, for example, heat-denatured egg yolk soil, even if a washing liquid is reused to have a liquid property in the region of neutrality to weak alkalinity during washing with an automatic dishwasher, and that do not cause much reduction in washing power due to pH changes.

According to the fourth method for washing a hard surface of the present invention, provided is a method for washing a hard surface that can achieve effective washing of soil containing protein adhering to a hard surface even if a liquid property is in the region of neutrality to weak alkalinity.

### EMBODIMENTS OF THE INVENTION

### [First Detergent Composition for Use in Automatic Dishwasher and First Method for Washing Tableware]

It is not wholly certain why the first detergent composition for use in an automatic dishwasher and the first method for washing tableware of the present invention can achieve effective washing of soil containing protein, for example, soil of egg yolk protein or the like, by washing with a dishwasher even if a liquid property is in the region of neutrality to weak alkalinity, but it is inferred to be as follows.

As a result of analyzing protein soil difficult to wash such as dried egg yolk soil or the like, the present inventors found that a factor in making such soil less likely to be removed or dispersed by surfactants or the like contained in detergents is ascribable to disulfide bonds (—SS— bonds) within protein molecules or between molecules in a protein structure stabilizing the structure, thereby forming a structure in which swelling or dispersion by surfactants is less likely to occur. It is then considered that, in the present invention, as disulfide bonds in a protein structure contained in protein soil difficult to wash are cleaved by using a reducing agent with a specific oxidation-reduction potential, component (a), in combination with a specific surfactant, component (c1), protein soil difficult to wash can be easily removed from tableware and dispersed in water even in the region of neutrality to weak alkalinity. It is then considered that it is important that a reducing agent of component (a) have reducibility capable of cleaving disulfide bonds, and if component (a) has an oxidation-reduction potential equal to or less than +71 mV which is an oxidation-reduction potential of disulfide bonds, disulfide bonds can be cleaved to a sufficient degree even in a short washing time for a dishwasher for business use. Further, a low-foaming anionic surfactant of component (c1) adsorbs to protein and makes the surface of protein negatively charged, thereby inducing steric repulsion between protein molecules. It is considered that this changes the steric structure of protein to a relatively-loose structure, thereby making it possible to act also on disulfide bonds present therein, resulting in synergistically exhibited high washing effects.

Note that the acting mechanism by which the present invention exhibits its effect is not limited to the above.

### [First Detergent Composition for Use in Automatic Dishwasher]

<Component (a)>

Component (a) is a reducing agent with an oxidation-reduction potential of +71 mV or less.

An oxidation-reduction potential of component (a) is +71 mV or less, preferably +60 mV or less, more preferably +55 mV or less and further preferably +50 mV or less from the viewpoint of protein washing performance. Further, the lower a lower limit of an oxidation-reduction potential of component (a) is, the more the effect can be expected, and it is not particularly limited to, but preferably 0 mV or more and more preferably 3 mV or more from the viewpoint of availability.

As an oxidation-reduction potential of component (a), a value measured by the following method is used. Distilled water is added to component (a) such that the concentration is 0.016 mol/L, and 1 mol/L hydrochloric acid and/or sodium hydroxide are added to adjust the pH to 7.5 to prepare a conditioned liquid. The temperature of the conditioned liquid is adjusted to 60° ° C., and the oxidation-reduction potential is measured with an oxidation-reduction potentiometer (for example, an ORP measuring instrument manufactured by CEM corporation Co., Ltd. (ORP5 PEN ORP meter)).

Component (a) is specifically one or more selected from a sulfite, a disulfate, a thiosulfate and an iodide salt, and specific examples include one or more selected from sodium sulfite (+50 mV), potassium sulfite (+50 mV), sodium disulfate (+17 mV), potassium disulfate (+17 mV), potassium iodide (+28 mV), sodium iodide (+28 mV), sodium thiosulfate (+5 mV) and potassium thiosulfate (+5 mV). Component (a) is not particularly limited as long as it has an oxidation-reduction potential of +71 mV or less, but preferably one or more selected from sodium sulfite, sodium disulfate, potassium iodide and sodium thiosulfate and more preferably one or more selected from sodium sulfite, sodium disulfate and sodium thiosulfate from the viewpoints of protein washing performance and availability. Note that shown in parentheses are oxidation-reduction potential values.

<Component (c1)>

Component (c1) is a low-foaming anionic surfactant.

In the present invention, a low-foaming anionic surfactant refers to an anionic surfactant that forms foam with a height of 2 cm or less when 100 mL of a 0.05 mass % aqueous solution of the anionic surfactant contained in a beaker is poured into a 200-mL glass graduated cylinder (for example, PYREX®) from a position 5 cm vertically upper than the opening of the graduated cylinder for 5 seconds at an almost constant rate so as not to come in contact with the side surface of the graduated cylinder, and after 30 seconds have passed from pouring, the height of foam is measured.

Examples of such a component (c1) include an anionic surfactant having a hydrocarbon group with 6 or more and 11 or less carbons, and more specific examples can include one or more selected from a sulfate having a hydrocarbon group with 6 or more and 11 or less carbons, a sulfonic acid having a hydrocarbon group with 6 or more and 11 or less carbons, a fatty acid with 6 or more and 10 or less carbons and salts of these, and from the viewpoint of protein washing performance, one or more selected from a sulfate having a hydrocarbon group with 6 or more and 11 or less carbons, a sulfonic acid having a hydrocarbon group with 6 or more and 11 or less carbons and salts of these are preferable. Salts of these anionic surfactants may be, for example, alkali metal salts such as sodium salts, potassium salts or the like, ammonium salts or the like.

Component (c1) is preferably one or more selected from an alkyl or alkenyl sulfate with 6 or more and 11 or less carbons, an alkyl or alkenyl sulfonic acid with 6 or more and 11 or less carbons and salts of these from the viewpoints of protein washing performance and anti-foaming performance. The above carbon number is the carbon number of an alkyl group or an alkenyl group.

An alkyl group or an alkenyl group has 6 or more and preferably 8 or more carbons from the viewpoint of protein washing performance and preferably 10 or less carbons from the viewpoint of anti-foaming performance, and is a straight chain or a branched chain and preferably a straight chain. Further, the carbon of an alkyl group or an alkenyl group bonded to a sulfate group or a sulfonic acid group is preferably a primary carbon from the viewpoint of protein washing performance. A salt of an alkyl or alkenyl sulfate with 6 or more and 11 or less carbons or an alkyl or alkenyl sulfonic acid with 6 or more and 11 or less carbons may be, for example, an alkali metal salt such as a sodium salt, a potassium salt or the like, an ammonium salt or the like. Component (c1) is preferably, for example, an alkyl sulfate with 10 carbons or a salt thereof from the viewpoint of protein washing performance.

### <Composition and Others>

The first detergent composition for use in an automatic dishwasher of the present invention can contain component (a) in an amount of preferably 0.0001 mass % or more, more preferably 0.0005 mass % or more, further preferably 0.001 mass % or more, furthermore preferably 0.002 mass % or more, furthermore preferably 0.005 mass % or more, furthermore preferably 0.05 mass % or more, furthermore preferably 0.1 mass % or more, furthermore preferably 0.5 mass % or more, furthermore preferably 1 mass % or more and furthermore preferably 3 mass % or more from the viewpoints of protein washing performance and formulation in consideration of workability, and preferably 30 mass % or less, more preferably 20 mass % or less, further preferably 10 mass % or less, furthermore preferably 8 mass % or less and furthermore preferably 6 mass % or less from the viewpoints of protein washing performance and the stability of properties as a formulation.

When the first detergent composition for use in an automatic dishwasher of the present invention is a formulation that can be used as-is without dilution (thin formulation), it can contain component (a) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoint of protein washing performance. Note that even if the concentration of a formulation falls within this range, the formulation may also be used after dilution.

When the first detergent composition for use in an automatic dishwasher of the present invention is a formulation that can be used after dilution (thick formulation), it can contain component (a) in an amount of, for example, preferably 0.05 mass % or more, more preferably 0.1 mass % or more, further preferably 0.5 mass % or more, furthermore preferably 1 mass % or more and furthermore preferably 3 massy or more from the viewpoint of protein washing performance, and preferably 30 mass % or less, more preferably 20 mass % or less, further preferably 10 mass % or less, furthermore preferably 8 mass % or less and furthermore preferably 6 mass % or less from the viewpoints of protein washing performance and the stability of properties as a formulation. Note that even if the concentration of a formulation falls within this range, the formulation may also be used without dilution.

The first detergent composition for use in an automatic dishwasher of the present invention can contain component (c1) in an amount of preferably 0.0001 mass % or more, more preferably 0.0005 mass % or more, further preferably 0.001 mass % or more, furthermore preferably 0.002 mass % or more, furthermore preferably 0.005 mass % or more, furthermore preferably 0.05 mass % or more, furthermore preferably 0.1 mass % or more, furthermore preferably 0.5 mass % or more, furthermore preferably 1 mass % or more, furthermore preferably 2 mass % or more and furthermore preferably 3 mass % or more from the viewpoints of protein washing performance and formulation in consideration of workability, and preferably 50 mass % or less, more preferably 30 mass % or less, further preferably 20 mass % or less, furthermore preferably 10 mass % or less, furthermore preferably 8 mass % or less and furthermore preferably 6 mass % or less from the viewpoints of protein washing performance and the stability of properties as a formulation.

When the first detergent composition for use in an automatic dishwasher of the present invention is a formulation that can be used as-is without dilution (thin formulation), it can contain component (c1) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoint of protein washing performance. Note that even if the concentration of a formulation falls within this range, the formulation may also be used after dilution.

When the first detergent composition for use in an automatic dishwasher of the present invention is a formulation that can be used after dilution (thick formulation), it can contain component (c1) in an amount of, for example, preferably 0.05 mass % or more, more preferably 0.1 mass % or more, further preferably 0.5 mass % or more, furthermore preferably 1 mass % or more, furthermore preferably 2 mass % or more and furthermore preferably 3 mass % or more from the viewpoint of protein washing performance, and preferably 50 mass % or less, more preferably 30 mass % or less, further preferably 20 mass % or less, furthermore preferably 10 mass % or less, furthermore preferably 8 mass % or less and furthermore preferably 6 mass % or less from the viewpoints of protein washing performance and the stability of properties as a formulation. Note that even if the concentration of a formulation falls within this range, the formulation may also be used without dilution.

Note that, in the present invention, a value calculated by assuming that component (c1) is a sodium salt is used for the specification relating to the mass of component (c1).

When the first detergent composition for use in an automatic dishwasher of the present invention is a formulation that can be used after dilution (thick formulation), a total content of components (a) and (c1) therein is preferably 3 mass % or more, more preferably 5 mass % or more, more preferably 7 mass % or more, further preferably 8 mass % or more and furthermore preferably 9 mass % or more, and preferably 20 mass % or less, more preferably 15 mass % or less and furthermore preferably 13 mass % or less from the viewpoint of washing power.

In the first detergent composition for use in an automatic dishwasher of the present invention, a mass ratio of a content of component (a) to a content of component (c1), (a)/(c1), is preferably 0.01 or more, more preferably 0.05 or more, further preferably 0.08 or more and furthermore preferably 0.1 or more, and preferably 10 or less, more preferably 8 or less, further preferably 6 or less, furthermore preferably 4 or less and furthermore preferably 3.5 or less from the viewpoint of protein washing performance.

The first detergent composition for use in an automatic dishwasher of the present invention can further contain a chelating agent as component (b) from the viewpoints of protein washing performance and the suppression of scale within an automatic dishwasher's chamber.

Component (b) is preferably a chelating agent with a conditional calcium stability constant pK′Ca of 2.6 or more at a pH of 7.5 and 60° C. from the viewpoints of protein washing performance and the suppression of scale within an automatic dishwasher's chamber.

A conditional calcium stability constant pK′Ca of component (b) at a pH of 7.5 and 60° C. is preferably 2.6 or more and more preferably 2.7 or more from the viewpoints of protein washing performance and the suppression of scale within an automatic dishwasher's chamber, further preferably 3 or more and furthermore preferably 3.2 or more from the viewpoint of protein washing performance, and preferably 15 or less, more preferably 10 or less and further preferably 6 or less from the viewpoint of availability.

As a conditional calcium stability constant pK′Ca of component (b) at a pH of 7.5 and 60° C., a value measured by the method below is used.

A calcium chloride solution at 25° C. and 2 g/L is added dropwise into 100 mL of distilled water at 60° C. by an amount of 0.2 mL, the potential at that time is measured with a calcium ion-selective electrode (for example, manufactured by HORIBA, Ltd.), and the equation for the first-order approximation is obtained with the logarithm of the calcium ion concentration for each dropwise-addition amount as the horizontal axis and the potential as the vertical axis. Subsequently, distilled water is added to component (b) such that the concentration is conditioned to 1 g/L, and the pH is adjusted to 7.5 with 1N sodium hydroxide and/or 1N hydrochloric acid, thereby preparing a chelating agent solution. 100 mL of the chelating agent solution is taken out and heated to 60° C., 3 mL of a calcium chloride solution at 25° C. and 2 g/L is added dropwise thereto, and the potential is measured with a calcium ion-selective electrode (for example, manufactured by HORIBA, Ltd.). The potential at that time is substituted into the approximation equation to determine concentration A of uncaptured calcium in the chelating agent solution (mol/L), and it is substituted into the formula below together with concentration B of the chelating agent (mol/L), thereby determining K′Ca to give the logarithm as pK′Ca.

K′Ca=(5.4×10⁻⁵−A)/(A×(B−(5.4×10⁻⁵−A)))

Specific examples of component (b) include one or more selected from ethylenediaminetetraacetic acid (pK′Ca 6.0), hexametaphosphoric acid (pK′Ca 5.7), a polyacrylic acid (pK′Ca 4.2), an acrylic acid-maleic acid copolymer (pK′Ca about 4.6 (which can vary depending on the monomer ratio)), citric acid (pK′Ca 3.4), tripolyphosphoric acid (pK′Ca 3.8), nitrilotriacetic acid (pK′Ca 2.9), a glutamate diacetate salt (pK′Ca 2.7) and salts of these, and from the viewpoint of protein washing performance, one or more selected from ethylenediaminetetraacetic acid, hexametaphosphoric acid, a polyacrylic acid, an acrylic acid-maleic acid copolymer, citric acid, tripolyphosphoric acid, nitrilotriacetic acid, a glutamate diacetate salt and salts of these are preferable, one or more selected from ethylenediaminetetraacetic acid, hexametaphosphoric acid, a polyacrylic acid, an acrylic acid-maleic acid copolymer, citric acid and salts of these are more preferable, and one or more selected from a polyacrylic acid, citric acid and salts of these are further preferable. Examples of the salts include alkali metal salts such as sodium salts, potassium salts or the like, ammonium salts or alkanolamine salts such as monoethanolamine salts, triethanolamine salts or the like, and potassium salts or sodium salts are preferable from the viewpoint of availability.

A polyacrylic acid or a salt thereof of component (b) may be a copolymer containing a monomer which is other than acrylic acid and is copolymerizable with acrylic acid (excluding maleic acid). A molar ratio of a monomer copolymerizable with acrylic acid (excluding maleic acid) in all the constituent monomers is 0 mol % or more, and 5 mol % or less, preferably 3 mol % or less and more preferably 0 mol % from the viewpoint of protein washing performance. Further, a weight average molecular weight of a polyacrylic acid or a salt thereof of component (b) is 1,000 or more and preferably 2,000 or more, and 20,000 or less and preferably 17,000 or less from the viewpoints of protein washing performance and workability. This weight average molecular weight is determined by gel permeation chromatography using a mixed solvent of acetonitrile and water (a phosphoric acid buffer solution) as a developing solvent, and a polyacrylic acid, a polymeric standard reagent with a known molecular weight which is generally on the market and available (for example, a molecular weight standard reagent manufactured by Sigma-Aldrich) as a standard substance.

In an acrylic acid-maleic acid copolymer or a salt thereof of component (b), a molar ratio of acrylic acid to maleic acid is 0.25 or more and preferably 0.4 or more, and 4 or less and preferably 2.5 or less from the viewpoint of protein washing performance. An acrylic acid-maleic acid copolymer or a salt thereof of component (b) may be a copolymer containing a monomer which is other than acrylic acid and maleic acid and is copolymerizable with acrylic acid and/or maleic acid. A molar ratio of a monomer which is other than acrylic acid and maleic acid and is copolymerizable with acrylic acid and/or maleic acid in all the constituent monomers is 0 mol % or more, and 5 mol % or less, preferably 3 mol % or less and more preferably 0 mol % from the viewpoint of protein washing performance. Further, a weight average molecular weight of an acrylic acid-maleic acid copolymer or a salt thereof of component (b) is 1,000 or more and preferably 2,000 or more, and preferably 100,000 or less and more preferably 90,000 or less from the viewpoints of protein washing performance and workability. This weight average molecular weight is determined by gel permeation chromatography using a mixed solvent of acetonitrile and water (a phosphoric acid buffer solution) as a developing solvent, and a polyacrylic acid, a polymeric standard reagent with a known molecular weight which is generally on the market and available (for example, a molecular weight standard reagent manufactured by Sigma-Aldrich) as a standard substance.

The first detergent composition for use in an automatic dishwasher of the present invention can contain component (b) in an amount of preferably 0.0001 mass % or more, more preferably 0.0005 mass % or more, further preferably 0.001 mass % or more, furthermore preferably 0.002 mass % or more, furthermore preferably 0.005 massy or more, furthermore preferably 0.05 masse or more, furthermore preferably 0.1 mass % or more, furthermore preferably 0.5 mass % or more, furthermore preferably 1 mass % or more, furthermore preferably 3 mass % or more and furthermore preferably 6 mass % or more, and preferably 40 mass % or less, more preferably 20 mass % or less, further preferably 18 mass % or less, furthermore preferably 15 mass % or less and furthermore preferably 12 mass % or less from the viewpoints of protein washing performance, formulation in consideration of workability and the suppression of scale within an automatic dishwasher's chamber.

When the first detergent composition for use in an automatic dishwasher of the present invention is a formulation that can be used as-is without dilution (thin formulation), it can contain component (b) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 0.2 mass % or less, more preferably 0.15 mass % or less, further preferably 0.1 mass % or less and furthermore preferably 0.05 mass % or less from the viewpoints of protein washing performance and the suppression of scale within an automatic dishwasher's chamber. Note that even if the concentration of a formulation falls within this range, the formulation may also be used after dilution.

When the first detergent composition for use in an automatic dishwasher of the present invention is a formulation that can be used after dilution (thick formulation), it can contain component (b) in an amount of, for example, preferably 0.05 mass % or more, more preferably 0.1 mass % or more, further preferably 0.5 mass % or more, furthermore preferably 1 mass % or more, furthermore preferably 3 mass % or more and furthermore preferably 6 mass % or more, and preferably 40 mass % or less, more preferably 20 mass % or less, further preferably 18 masse or less, furthermore preferably 15 mass % or less and furthermore preferably 12 mass % or less from the viewpoints of protein washing performance and the suppression of scale within an automatic dishwasher's chamber. Note that even if the concentration of a formulation falls within this range, the formulation may also be used without dilution.

Note that, in the present invention, a value calculated by assuming that component (b) is a sodium salt is used for the specification relating to the mass of component (b).

In the first detergent composition for use in an automatic dishwasher of the present invention, a mass ratio of a content of component (a) to a content of component (b), (a)/(b), is preferably 0.05 or more, more preferably 0.1 or more, further preferably 0.2 or more, furthermore preferably 0.3 or more and furthermore preferably 0.4 or more, and preferably 3 or less, more preferably 2.5 or less, further preferably 2 or less, furthermore preferably 1.5 or less, furthermore preferably 1 or less and furthermore preferably 0.8 or less from the viewpoints of protein washing performance and the suppression of scale within an automatic dishwasher's chamber.

The first detergent composition for use in an automatic dishwasher of the present invention can further contain a nonionic surfactant as component (d) from the viewpoints of protein washing performance, oil washing performance and finishing performance for washed articles.

Examples of a nonionic surfactant of component (d) include a polyoxyalkylene alkyl ether, a polyoxyalkylene alkenyl ether, a polyoxyalkylene sorbitan fatty acid ester, an alkyl glycoside, an alkyl polyglycoside, a sucrose fatty acid ester, an alkyl polyglyceryl ether or the like, and one or two or more of these can be used. These nonionic surfactants have an alkyl group or an alkenyl group with preferably 6 or more and more preferably 8 or more, and preferably 22 or less and more preferably 18 or less carbons from the viewpoint of protein washing performance. An alkylene oxide of a polyoxyalkylene alkyl ether, a polyoxyalkylene alkenyl ether or a polyoxyalkylene sorbitan fatty acid ester preferably includes an alkylene oxide selected from ethylene oxide and propylene oxide from the viewpoint of protein washing performance, and an average number of added moles of an alkylene oxide is preferably 2 or more and preferably 25 or less from the viewpoint of protein washing performance.

A nonionic surfactant is preferably a polyoxyalkylene alkyl ether [hereinafter referred to as component (d1)]. An alkyl group in component (d1) has preferably 10 or more and more preferably 12 or more, and preferably 20 or less, more preferably 18 or less and further preferably 16 or less carbons from the viewpoint of protein washing performance. An alkylene oxide in component (d1) preferably includes an alkylene oxide selected from ethylene oxide and propylene oxide from the viewpoint of protein washing performance. Further, an average number of added moles of an alkylene oxide in component (d1) is preferably 2 or more, more preferably 4 or more, further preferably 6 or more, furthermore preferably 8 or more and furthermore preferably 10 or more, and preferably 20 or less and more preferably 18 or less from the viewpoint of protein washing performance.

Examples of component (d1) include a secondary alcohol alkylene oxide adduct with 10 or more and 24 or less carbons. The secondary alcohol has preferably 10 or more and more preferably 12 or more, and preferably 20 or less, more preferably 18 or less and further preferably 16 or less carbons from the viewpoint of protein washing performance. An alkylene oxide is preferably an alkylene oxide with 2 or more and 4 or less carbons from the viewpoint of protein washing performance. An alkylene oxide preferably includes an alkylene oxide selected from ethylene oxide and propylene oxide from the viewpoint of protein washing performance. An average number of added moles of an alkylene oxide is preferably 2 or more, more preferably 4 or more, further preferably 6 or more, furthermore preferably 8 or more and furthermore preferably 10 or more, and preferably 20 or less and more preferably 18 or less from the viewpoint of protein washing performance.

The first detergent composition for use in an automatic dishwasher of the present invention can contain component (d) in an amount of preferably 0.00001 mass % or more, more preferably 0.0001 mass % or more, further preferably 0.0005 mass % or more, furthermore preferably 0.001 mass % or more, furthermore preferably 0.005 mass % or more, furthermore preferably 0.05 mass % or more, furthermore preferably 0.1 mass % or more, furthermore preferably 0.5 mass % or more, furthermore preferably 1 mass % or more and furthermore preferably 2 mass % or more, and preferably 15 mass % or less, more preferably 10 mass % or less, further preferably 8 mass % or less, furthermore preferably 7 mass % or less, furthermore preferably 6 mass % or less and furthermore preferably 4 mass % or less from the viewpoints of protein washing performance, oil washing performance, formulation in consideration of workability and finishing performance for washed articles.

When the first detergent composition for use in an automatic dishwasher of the present invention is a formulation that can be used as-is without dilution (thin formulation), it can contain component (d) in an amount of, for example, preferably 0.00001 mass % or more, more preferably 0.0001 mass % or more, further preferably 0.0005 mass % or more, furthermore preferably 0.001 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance, oil washing performance and finishing performance for washed articles. Note that even if the concentration of a formulation falls within this range, the formulation may also be used after dilution.

When the first detergent composition for use in an automatic dishwasher of the present invention is a formulation that can be used after dilution (thick formulation), it can contain component (d) in an amount of, for example, preferably 0.05 mass % or more, more preferably 0.1 mass % or more, further preferably 0.5 mass % or more, furthermore preferably 1 mass % or more and furthermore preferably 2 mass % or more, and preferably 15 mass % or less, more preferably 10 mass % or less, further preferably 8 mass % or less, furthermore preferably 7 mass % or less, furthermore preferably 6 mass % or less and furthermore preferably 4 mass % or less from the viewpoints of protein washing performance, oil washing performance and finishing performance for washed articles. Note that even if the concentration of a formulation falls within this range, the formulation may also be used without dilution.

In the first detergent composition for use in an automatic dishwasher of the present invention, a mass ratio of a content of component (a) to a content of component (d), (a)/(d), is preferably 0.1 or more, more preferably 0.2 or more, further preferably 0.3 or more and furthermore preferably 0.4 or more, and preferably 5.0 or less, more preferably 4.0 or less, further preferably 3.0 or less and furthermore preferably 2.0 or less from the viewpoints of protein washing performance, oil washing performance and finishing performance for washed articles.

In the first detergent composition for use in an automatic dishwasher of the present invention, the ranges of the contents of components (a), (c1), (b) and (d) can each be set by arbitrarily selecting numerical values from the above and combining them.

A pH of the first detergent composition for use in an automatic dishwasher of the present invention at 25° C. is 6 or more, preferably 6.2 or more and more preferably 6.5 or more, and 11 or less, preferably 10 or less and more preferably 9 or less from the viewpoint of reducing the risk of chemical injuries. This pH is measured by the measurement method below.

### (1) pH Measurement Method

A composite electrode for pH measurements (for example, manufactured by HORIBA, Ltd., glass slide-in sleeve type) with a saturated potassium chloride aqueous solution (3.33 mol/L) as the pH electrode internal solution is connected to a pH meter (for example, pH/ion meter F-23 manufactured by HORIBA, Ltd.). Next, a pH 4.01 standard solution (phthalate standard solution), a pH 6.86 standard solution (neutral phosphate standard solution) and a pH 9.18 standard solution (borate standard solution) are each filled into a 100 mL-beaker, and immersed in a constant temperature bath at 25° C. for 30 minutes. The electrode for pH measurements is immersed in the standard solutions adjusted to be at a constant temperature for 3 minutes to perform a calibration operation in the order of pH 6.86, pH 9.18 and pH 4.01. The temperature of the detergent composition for use in an automatic dishwasher to be measured is adjusted to 25° C., the electrode of the pH meter is immersed in the sample, and the pH 1 minute later is measured.

A pH at 25° C. of a diluted product of the first detergent composition for use in an automatic dishwasher of the present invention diluted with water at a concentration of 0.2 mass % is preferably 6 or more and more preferably 6.5 or more, and preferably 10.5 or less and more preferably 9 or less from the viewpoints of reducing the risk of chemical injuries and reducing environmental burdens by reducing the pH of wastewater. This pH is measured by the above measurement method (provided that the detergent composition for use in an automatic dishwasher is read as the diluted product of the detergent composition for use in an automatic dishwasher).

The first detergent composition for use in an automatic dishwasher of the present invention preferably contains water from the viewpoints of the stability of the composition and workability. Examples of water are not particularly limited to, but include tap water, well water, ion exchange water, distilled water or the like. This water is preferably used in an amount of the balance of the composition (an amount making the total 100 mass %). A content of water in the composition can be, for example, 20 mass % or more, further 30 mass % or more, further 50 mass % or more, further 55 mass % or more, further 60 mass % or more, further 65 mass % or more and further 70 mass % or more.

The first detergent composition for use in an automatic dishwasher of the present invention can be formulated with components such as a surfactant, an enzyme (a proteolytic enzyme, a lipolytic enzyme, a glycolytic enzyme or the like), a solvent, a hydrotropic agent, a dispersant, a pH adjuster, a thickener, a viscosity adjuster, a fragrance, a colorant, an anti-oxidant, an antiseptic, an anti-foaming agent, a bleaching agent, a bleach activator or the like (excluding those qualifying for components (a), (c1), (b) and (d)) in the range that the purpose of the present invention is not impaired.

A viscosity of the first detergent composition for use in an automatic dishwasher of the present invention at 20° C. may be, for example, 1200 mPa·s or less and further 1000 mPa·s or less from the viewpoint of protein washing performance. A lower limit of the viscosity may be 0 mPa·s or more. This viscosity is measured with a B-type viscometer.

In the present invention, tableware may mean including members or utensils coming in contact with foodstuffs such as,
in addition to (i) so-called tableware such as a dish, a bowl, a cup, chopsticks, a knife, a fork, a spoon or the like,
(ii) storage jars such as Tupperware®, a bottle or the like,
(iii) cooking utensils such as a kitchen knife, a chopping board, a pan, a fry pan, a fish grill or the like and
(iv) containing or carrying utensils such as a rack, a container or the like, and others.

### <First Method for Washing Tableware>

The present invention provides a first method for washing tableware including, washing, by using an automatic dishwasher, tableware adhered with soil containing protein with a washing liquid prepared by diluting the first detergent composition for use in an automatic dishwasher of the present invention with water (hereinafter referred to as a first washing liquid of the present invention).

The matters stated in the first detergent composition for use in an automatic dishwasher of the present invention can be appropriately applied to the first method for washing tableware of the present invention. The specific examples or preferable examples of component (a), component (c1), component (b), component (d), each mass ratio, pH and tableware are also the same as those in the first detergent composition for use in an automatic dishwasher of the present invention.

The first washing liquid of the present invention may be prepared by diluting the first detergent composition for use in an automatic dishwasher of the present invention with water by a factor of more than one and further 300 or more, and 2000 or less and further 1500 or less.

The first washing liquid of the present invention can contain component (a) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoint of protein washing performance.

The first washing liquid of the present invention can contain component (c1) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoint of protein washing performance.

The first washing liquid of the present invention can contain component (b) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 0.2 mass % or less, more preferably 0.15 mass % or less, further preferably 0.1 mass % or less and furthermore preferably 0.05 mass % or less from the viewpoints of protein washing performance and the suppression of scale within an automatic dishwasher's chamber.

The first washing liquid of the present invention can contain component (d) in an amount of, for example, preferably 0.00001 mass % or more, more preferably 0.0001 mass % or more, further preferably 0.0005 mass % or more, furthermore preferably 0.001 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance, oil washing performance and finishing performance for washed articles.

In the present invention, the ranges of the contents of components (a), (c1), (b) and (d) in the first washing liquid can each be set by arbitrarily selecting numerical values from the above and combining them.

A pH of the first washing liquid of the present invention is preferably 6 or more, more preferably 6.2 or more and further preferably 6.5 or more, and preferably 10.5 or less, more preferably 10.2 or less, further preferably 10 or less and furthermore preferably 9 or less from the viewpoints of reducing the risk of chemical injuries and reducing environmental burdens by reducing the pH of wastewater.

In the first method for washing tableware of the present invention, the first washing liquid is brought into contact with the tableware for, for example, 20 seconds or more, further 30 seconds or more and further 40 seconds or more, and 600 seconds or less, further 300 seconds or less and further 180 seconds or less from the viewpoint of protein washing performance.

In the first method for washing tableware of the present invention, a temperature of the first washing liquid can be, for example, 30° C. or more, further 35° C. or more and further 40° C. or more, and 90° C. or less, further 80ºC or less and further 70° C. or less.

In the first method for washing tableware of the present invention, a flow rate when the first washing liquid is brought into contact with the tableware can be preferably 5 m/min or more, more preferably 10 m/min or more and further preferably 50 m/min or more, and preferably 2000 m/min or less, more preferably 1000 m/min or less and more preferably 500 m/min or less from the viewpoint of protein washing performance.

The soil containing protein may be soil containing protein derived from egg yolk.

After the first washing liquid is brought into contact with the tableware, the tableware is rinsed with water. A temperature of water for rinsing the tableware is 50° C. or more, preferably 55° C. or more and more preferably 60° C. or more, and 80° ° C. or less.

A time for rinsing the tableware is 4 seconds or more and preferably 5 seconds or more, and 10 seconds or less and preferably 9 seconds or less.

A flow rate of rinsing water can be preferably 5 m/min or more, more preferably 10 m/min or more and further preferably 100 m/min or more, and preferably 2500 m/min or less, more preferably 2000 m/min or less, further preferably 1500 m/min or less, further preferably 250 m/min or less and furthermore preferably 150 m/min or less.

In the present invention, an automatic dishwasher may be any dishwasher generally available on the market, and an automatic dishwasher for home use can also be used, although an automatic dishwasher for business use is preferable. In washing with a dishwasher for business use, the detergent composition for use in an automatic dishwasher of the present invention is generally mixed with water and used as a washing liquid. In such washing, a certain amount of the composition is arbitrarily transferred through a supplying device to the inside of a dishwasher for business use to maintain an appropriate concentration of the washing liquid. For example, the detergent composition for use in an automatic dishwasher of the present invention is pumped and supplied through a tube dedicated to a dishwasher for business use inserted directly into a container made of plastic or the like filled with the composition. The washing liquid is then supplied to the inside of the dishwasher for business use.

### [Second Detergent Composition for Use in Automatic Dishwasher and Second Method for Washing Tableware]

It is not wholly certain why the second detergent composition for use in an automatic dishwasher and the second method for washing tableware of the present invention can achieve effective washing of soil containing protein by washing with a dishwasher even if a liquid property is in the region of neutrality to weak alkalinity, but it is inferred to be as follows.

As a result of analyzing protein soil difficult to wash such as dried egg yolk soil or the like, the present inventors found that a factor in making such soil less likely to be removed or dispersed by surfactants or the like contained in detergents is ascribable to disulfide bonds (—SS— bonds) within protein molecules or between molecules in a protein structure stabilizing the structure, and phosphoric acid-Ca cross-linking structures that phosphoric acid groups in a protein structure form via Ca ions within protein molecules or between molecules stabilizing the structure, thereby forming a structure in which swelling or dispersion by surfactants is less likely to occur. It is then considered that, in the present invention, as disulfide bonds in a protein structure are cleaved by a reducing agent with a specific oxidation-reduction potential, component (a), and further, phosphoric acid-Ca cross-links in a protein structure are cleaved by a chelating agent with a specific conditional calcium stability constant pK′Ca, component (b1), protein difficult to wash can be easily removed from tableware and dispersed in water even in the region of neutrality to weak alkalinity. It is then considered that it is important that the reducing agent have reducibility capable of cleaving disulfide bonds and has an oxidation-reduction potential equal to or less than +71 mV which is an oxidation-reduction potential of disulfide bonds, and it is important that the chelating agent have chelating ability capable of cleaving phosphoric acid-Ca cross-links, and when a pK′Ca of calcium phosphate is 3.2 or more, the structure of protein difficult to wash can be synergistically loosened, and disulfide bonds and phosphoric acid-Ca cross-links in a protein structure can be cleaved to a sufficient degree even in a short washing time for a dishwasher for business use.

Note that the acting mechanism by which the present invention exhibits its effect is not limited to the above.

### [Second Detergent Composition for Use in Automatic Dishwasher]

<Component (b1)>

Component (b1) is a chelating agent with a conditional calcium stability constant pK′Ca of 3.2 or more at a pH of 7.5 and 60° C.

A conditional calcium stability constant pK′Ca of component (b1) is preferably 3.3 or more and more preferably 3.4 or more from the viewpoint of protein washing performance. An upper limit of a pK′Ca of component (b1) is not limited in terms of calcium chelating ability, but preferably 15 or less, more preferably 10 or less and further preferably 6 or less from the viewpoint of availability.

A method for measuring a conditional calcium stability constant pK′Ca of component (b1) at a pH of 7.5 and 60° C. is the same as the measurement method described for a conditional calcium stability constant pK′Ca of component (b) at a pH of 7.5 and 60° C. in the first detergent composition for use in an automatic dishwasher of the present invention, and the method can be applied by reading component (b) as component (b1).

Specific examples of component (b1) include one or more selected from ethylenediaminetetraacetic acid (pK′Ca 6.0), hexametaphosphoric acid (pK′Ca 5.7), a polyacrylic acid (pK′Ca 4.2), an acrylic acid-maleic acid copolymer (pK′Ca about 4.6 (which can vary depending on the monomer ratio)), citric acid (pK′Ca 3.4), tripolyphosphoric acid (pK′Ca 3.8) and salts of these, and from the viewpoint of protein washing performance, one or more selected from ethylenediaminetetraacetic acid, hexametaphosphoric acid, a polyacrylic acid, an acrylic acid-maleic acid copolymer, citric acid and salts of these are preferable, and one or more selected from a polyacrylic acid, citric acid and salts of these are more preferable. Examples of the salts include alkali metal salts such as sodium salts, potassium salts or the like, ammonium salts or alkanolamine salts such as monoethanolamine salts, triethanolamine salts or the like, and potassium salts or sodium salts are preferable from the viewpoint of availability.

A polyacrylic acid or a salt thereof of component (b1) is the same as in the aspect described in component (b) of the first detergent composition for use in an automatic dishwasher of the present invention.

An acrylic acid-maleic acid copolymer or a salt thereof of component (b1) is the same as in the aspect described in component (b) of the first detergent composition for use in an automatic dishwasher of the present invention.

<Component (a)>

Component (a) is a reducing agent with an oxidation-reduction potential of +71 mV or less.

Component (a) is the same as component (a) described in the first detergent composition for use in an automatic dishwasher of the present invention, and the preferable aspects thereof are also the same.

### <Composition and Others>

The second detergent composition for use in an automatic dishwasher of the present invention can contain component (b1) in an amount of preferably 0.05 mass % or more, more preferably 0.1 masse or more, further preferably 0.5 mass % or more, furthermore preferably 1 mass % or more, furthermore preferably 2 mass % or more and furthermore preferably 3 mass % or more, and preferably 40 mass % or less, more preferably 20 mass % or less, further preferably 18 mass % or less, furthermore preferably 15 mass % or less and furthermore preferably 12 mass % or less from the viewpoint of protein washing performance.

Note that, in the present invention, a value calculated by assuming that component (b1) is a sodium salt is used for the specification relating to the mass of component (b1).

The second detergent composition for use in an automatic dishwasher of the present invention can contain component (a) in an amount of more than 0.5 mass %, preferably 0.6 mass % or more, more preferably 0.7 mass % or more, further preferably 0.8 mass % or more, furthermore preferably 1.0 mass % or more and furthermore preferably 2.0 mass % or more from the viewpoints of protein washing performance and formulation in consideration of workability, and 30 mass % or less, preferably 25 mass % or less, more preferably 20 mass % or less, further preferably 18 mass % or less and furthermore preferably 15 mass % or less from the viewpoints of protein washing performance and the stability of properties as a formulation.

In the second detergent composition for use in an automatic dishwasher of the present invention, a mass ratio of a content of component (a) to a content of component (b1), (a)/(b1), is preferably 0.05 or more, more preferably 0.08 or more, further preferably 0.1 or more, furthermore preferably 0.2 or more, furthermore preferably 0.3 or more and furthermore preferably 1 or more, and preferably 7 or less, more preferably 6 or less, further preferably 5 or less, furthermore preferably 4 or less, furthermore preferably 3 or less and furthermore preferably 2.5 or less from the viewpoint of protein washing performance.

The second detergent composition for use in an automatic dishwasher of the present invention can further contain a nonionic surfactant as component (d) from the viewpoints of protein washing performance, oil washing performance and finishing performance for washed articles.

Component (d) is the same as component (d) described in the first detergent composition for use in an automatic dishwasher of the present invention, and the preferable aspects thereof are also the same.

The second detergent composition for use in an automatic dishwasher of the present invention can contain component (d) in an amount of preferably 0.05 mass % or more, more preferably 0.1 mass % or more, further preferably 0.5 mass % or more, furthermore preferably 1 mass % or more and furthermore preferably 2 mass % or more, and preferably 15 mass % or less, more preferably 10 mass % or less, further preferably 8 mass % or less, furthermore preferably 7 mass % or less, furthermore preferably 6 mass % or less and furthermore preferably 4 mass % or less from the viewpoints of protein washing performance, oil washing performance and finishing performance for washed articles.

In the second detergent composition for use in an automatic dishwasher of the present invention, a mass ratio of a content of component (d) to a content of component (b1), (d)/(b1), is preferably 0.001 or more, more preferably 0.01 or more, further preferably 0.05 or more and furthermore preferably 0.1 or more, and preferably 8 or less, more preferably 5 or less, further preferably 1 or less, furthermore preferably 0.8 or less and furthermore preferably 0.5 or less from the viewpoints of washing performance and stability.

The second detergent composition for use in an automatic dishwasher of the present invention can further contain an anionic surfactant as component (c) from the viewpoint of protein washing performance.

Examples of component (c) include one or more selected from an alkyl or alkenyl benzene sulfonic acid, a polyoxyalkylene alkyl or alkenyl ether sulfate, an alkyl or alkenyl sulfate, an alkane sulfonic acid, an olefin sulfonic acid, a fatty acid and salts of these. These anionic surfactants have an alkyl group or an alkenyl group with preferably 6 or more and more preferably 8 or more, and preferably 22 or less and more preferably 18 or less carbons from the viewpoint of protein washing performance. Salts of these anionic surfactants may be, for example, alkali metal salts such as sodium salts, potassium salts or the like, ammonium salts or the like.

Component (c) is preferably an alkyl or alkenyl sulfate with 6 or more and 16 or less carbons or a salt thereof from the viewpoints of protein washing performance and anti-foaming performance.

The above carbon number is the carbon number of an alkyl group or an alkenyl group. An alkyl group or an alkenyl group has 6 or more, preferably 8 or more and more preferably 10 or more carbons from the viewpoint of protein washing performance and 16 or less, preferably 14 or less and more preferably 12 or less carbons from the viewpoint of anti-foaming performance, and is a straight chain or a branched chain and preferably a straight chain. Further, the carbon of an alkyl group or an alkenyl group bonded to a sulfate group is preferably a primary carbon from the viewpoint of protein washing performance. A salt of an alkyl or alkenyl sulfate with 6 or more and 16 or less carbons may be, for example, an alkali metal salt such as a sodium salt, a potassium salt or the like, an ammonium salt or the like. Component (c) is preferably, for example, an alkyl sulfate with 10 carbons or a salt thereof from the viewpoint of protein washing performance.

The second detergent composition for use in an automatic dishwasher of the present invention can contain component (c) in an amount of preferably 0.05 mass % or more, more preferably 0.1 mass % or more, further preferably 0.5 mass % or more, furthermore preferably 1 mass % or more and furthermore preferably 3 mass % or more from the viewpoint of protein washing performance, and preferably 50 mass % or less, more preferably 30 mass % or less, further preferably 20 mass % or less, furthermore preferably 10 mass % or less, furthermore preferably 8 mass % or less and furthermore preferably 6 mass % or less from the viewpoints of protein washing performance and the stability of properties as a formulation.

Note that, in the present invention, a value calculated by assuming that component (c) is a sodium salt is used for the specification relating to the mass of component (c).

In the second detergent composition for use in an automatic dishwasher of the present invention, a mass ratio of a content of component (c) to a content of component (b1), (c)/(b1), is preferably 0.001 or more, more preferably 0.01 or more, further preferably 0.05 or more and furthermore preferably 0.1 or more, and preferably 20 or less, more preferably 10 or less, further preferably 8 or less, furthermore preferably 5 or less, furthermore preferably 3 or less and furthermore preferably 1 or less from the viewpoint of protein washing performance.

In the second detergent composition for use in an automatic dishwasher of the present invention, the ranges of the contents of components (b1), (a), (d) and (c) can each be set by arbitrarily selecting numerical values from the above and combining them.

A pH of the second detergent composition for use in an automatic dishwasher of the present invention at 25° C. is 6 or more, preferably 6.2 or more and more preferably 6.5 or more, and 11 or less, preferably 10 or less and more preferably 9 or less from the viewpoint of reducing the risk of chemical injuries. A method for measuring this pH is the same as the pH measurement method described in the first detergent composition for use in an automatic dishwasher of the present invention.

A pH at 25° C. of a diluted product of the second detergent composition for use in an automatic dishwasher of the present invention diluted with water at a concentration of 0.1 mass % is preferably 6 or more and more preferably 6.5 or more, and preferably 10.5 or less and more preferably 9 or less from the viewpoints of reducing the risk of chemical injuries and reducing environmental burdens by reducing the pH of wastewater. This pH is measured by the measurement method described in the first detergent composition for use in an automatic dishwasher of the present invention (provided that the detergent composition for use in an automatic dishwasher is read as the diluted product of the detergent composition for use in an automatic dishwasher).

The second detergent composition for use in an automatic dishwasher of the present invention preferably contains water from the viewpoints of the stability of the composition and workability. Examples of water are not particularly limited to, but include tap water, well water, ion exchange water, distilled water or the like. This water is preferably used in an amount of the balance of the composition (an amount making the total 100 mass %). A content of water in the composition can be, for example, 20 mass % or more, further 30 mass % or more, further 50 mass % or more, further 55 mass % or more, further 60 mass % or more, further 65 mass % or more and further 70 mass % or more.

The second detergent composition for use in an automatic dishwasher of the present invention can be formulated with components such as a surfactant, an enzyme (a proteolytic enzyme, a lipolytic enzyme, a glycolytic enzyme or the like), a solvent, a hydrotropic agent, a dispersant, a pH adjuster, a thickener, a viscosity adjuster, a fragrance, a colorant, an anti-oxidant, an antiseptic, an anti-foaming agent, a bleaching agent, a bleach activator or the like (excluding those qualifying for components (b1), (a), (d) and (c)) in the range that the purpose of the present invention is not impaired.

A viscosity of the second detergent composition for use in an automatic dishwasher of the present invention at 20° C. may be, for example, 1200 mPa·s or less and further 1000 mPa·s or less from the viewpoint of protein washing performance. A lower limit of the viscosity may be 0 mPa·s or more. This viscosity is measured with a B-type viscometer.

In the present invention, tableware is the same as described in the first detergent composition for use in an automatic dishwasher of the present invention.

### <Second Method for Washing Tableware>

The present invention provides a second method for washing tableware including, washing, by using an automatic dishwasher, tableware adhered with soil containing protein with a washing liquid prepared by diluting the second detergent composition for use in an automatic dishwasher of the present invention with water (hereinafter referred to as a second washing liquid of the present invention).

The matters stated in the second detergent composition for use in an automatic dishwasher of the present invention can be appropriately applied to the second method for washing tableware of the present invention. The specific examples or preferable examples of component (b1), component (a), component (d), component (c), each mass ratio, pH and tableware are also the same as those in the second detergent composition for use in an automatic dishwasher of the present invention.

The second washing liquid of the present invention may be prepared by diluting the second detergent composition for use in an automatic dishwasher of the present invention with water by a factor of more than one and further 300 or more, and 2000 or less and further 1500 or less.

The second washing liquid of the present invention can contain component (b1) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 0.2 mass % or less, more preferably 0.15 mass % or less, further preferably 0.1 mass % or less and furthermore preferably 0.05 mass % or less from the viewpoint of protein washing performance.

The second washing liquid of the present invention can contain component (a) in an amount of preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoint of protein washing performance.

The second washing liquid of the present invention can contain component (d) in an amount of preferably 0.00001 mass % or more, more preferably 0.0001 mass % or more, further preferably 0.0005 mass % or more, furthermore preferably 0.001 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance, oil washing performance and finishing performance for washed articles.

The second washing liquid of the present invention can contain component (c) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance and the suppression of scale within a dishwasher's chamber.

The ranges of the contents of components (b1), (a), (d) and (c) in the second washing liquid of the present invention can each be set by arbitrarily selecting numerical values from the above and combining them.

A pH of the second washing liquid of the present invention is preferably 6 or more, more preferably 6.2 or more and further preferably 6.5 or more, and preferably 10.5 or less, more preferably 10.2 or less, further preferably 10 or less and furthermore preferably 9 or less from the viewpoints of reducing the risk of chemical injuries and reducing environmental burdens by reducing the pH of wastewater.

In the second method for washing tableware of the present invention, the second washing liquid is brought into contact with the tableware for, for example, 20 seconds or more, further 30 seconds or more and further 40 seconds or more, and 600 seconds or less, further 300 seconds or less and further 180 seconds or less from the viewpoint of protein washing performance.

In the second method for washing tableware of the present invention, a temperature of the second washing liquid can be, for example, 30° C. or more, further 35° C. or more and further 40° ° C. or more, and 90° ° C. or less, further 80° C. or less and further 70° C. or less.

In the second method for washing tableware of the present invention, a flow rate when the second washing liquid is brought into contact with the tableware can be preferably 5 m/min or more, more preferably 10 m/min or more and further preferably 50 m/min or more, and preferably 2000 m/min or less, more preferably 1000 m/min or less, more preferably 500 m/min or less, further preferably 250 m/min or less and furthermore preferably 150 m/min or less from the viewpoint of protein washing performance.

The soil containing protein may be soil containing protein derived from egg yolk.

After the second washing liquid is brought into contact with the tableware, the tableware is rinsed with water. A temperature of water for rinsing the tableware is 50° ° C. or more, preferably 55° C. or more and more preferably 60° C. or more, and 80° ° C. or less.

A time for rinsing the tableware is 4 seconds or more and preferably 5 seconds or more, and 10 seconds or less and preferably 9 seconds or less.

A flow rate of rinsing water is preferably 5 m/min or more, more preferably 10 m/min or more and further preferably 100 m/min or more, and preferably 2500 m/min or less, more preferably 2000 m/min or less and further preferably 1500 m/min or less.

In the present invention, an automatic dishwasher is the same as described in the first detergent composition for use in an automatic dishwasher and the first method for washing tableware of the present invention.

### [Third Detergent Composition for Use in Automatic Dishwasher and Third Method for Washing Tableware]

It is not wholly certain why in washing with an automatic dishwasher, the third detergent composition for use in a dishwasher and the third method for washing tableware of the present invention can achieve effective washing of soil containing protein, for example, heat-denatured egg yolk soil, even if a washing liquid is reused to have a liquid property in the region of neutrality to weak alkalinity, and do not cause much reduction in washing power due to pH changes, but it is inferred to be as follows.

Washing of food soil with a washing liquid containing an alkali agent is achieved as follows: in the case of the removal of protein soil, protein is hydrolyzed, and the protein is solubilized and dispersed by a negative charge of an amino acid residue; in the case of lipid soil, oils and fats are hydrolyzed to be fatty acid soaps, and they are solubilized and dispersed; and in the case of starch soil, starch is hydrolyzed to be short molecules, and they are solubilized and dispersed. However, in actual washing with an automatic dishwasher for business use where a washing liquid containing part of soil solubilized during washing is collected and utilized, a washing liquid at the start of washing is highly alkaline and shows good washing performance, but as the washing liquid is collected, the pH of the washing liquid is reduced by soluble acidic compounds such as fatty acids, amino acids or the like. In such a region of neutrality to weak alkalinity of a collected washing liquid, washing effects on food soil are reduced, and particularly, washing performance for protein is significantly reduced. It is considered that, while many proteins include disulfide bonds by which the structures thereof are stabilized, in the present invention, a specific reducing agent, component (a) cleaves disulfide bonds in protein, thereby solubilizing and dispersing protein in the region of neutrality to weak alkalinity of the pH of a collected washing liquid, so that washing power can be maintained without depending on pH. It is considered that, when a reducing agent of the present invention is a reducing agent with an oxidation-reduction potential equal to or less than +71 mV which is an oxidation-reduction potential of disulfide bonds, disulfide bonds can be cleaved even at a reduced pH of a collected washing liquid and further in short-time washing in an automatic dishwasher, so that high washing effects and maintained washing power can be exhibited.

Note that the acting mechanism by which the present invention exhibits its effect is not limited to the above.

### [Third Detergent Composition for Use in Automatic Dishwasher]

<Component (a)>

Component (a) is a reducing agent with an oxidation-reduction potential of +71 mV or less. Component (a) is the same as component (a) described in the first detergent composition for use in an automatic dishwasher of the present invention, and the preferable aspects thereof are also the same.

<Component (e)>

Component (e) is a hydroxide of an alkali metal.

Component (e) is preferably one or more selected from sodium hydroxide, potassium hydroxide and lithium hydroxide and more preferably one or more selected from sodium hydroxide and potassium hydroxide from the viewpoint of protein washing performance.

### <Composition and Others>

The third detergent composition for use in an automatic dishwasher of the present invention can contain component (a) in an amount of preferably 0.0001 mass % or more, more preferably 0.0005 mass % or more, further preferably 0.001 mass % or more, furthermore preferably 0.002 mass % or more, furthermore preferably 0.005 mass % or more, furthermore preferably 0.05 mass % or more, furthermore preferably 0.1 mass % or more, furthermore preferably 0.5 mass % or more and furthermore preferably 1 mass % or more from the viewpoints of protein washing performance, maintained protein washing performance and formulation in consideration of workability, and preferably 30 mass % or less, more preferably 20 mass % or less, further preferably 15 mass % or less, furthermore preferably 12 mass % or less and furthermore preferably 10 mass % or less from the viewpoints of protein washing performance and maintained protein washing performance.

When the third detergent composition for use in an automatic dishwasher of the present invention is a formulation that can be used as-is without dilution (thin formulation), it can contain component (a) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance and maintained protein washing performance. Note that even if the concentration of a formulation falls within this range, the formulation may also be used after dilution.

When the third detergent composition for use in an automatic dishwasher of the present invention is a formulation that can be used after dilution (thick formulation), it can contain component (a) in an amount of, for example, preferably 0.05 mass % or more, more preferably 0.1 mass % or more, further preferably 0.5 mass or more and furthermore preferably 1 mass % or more, and preferably 30 mass % or less, more preferably 20 mass % or less, further preferably 15 mass % or less, furthermore preferably 12 mass % or less and furthermore preferably 10 mass % or less from the viewpoints of protein washing performance and maintained protein washing performance. Note that even if the concentration of a formulation falls within this range, the formulation may also be used without dilution.

The third detergent composition for use in an automatic dishwasher of the present invention can contain component (e) in an amount of preferably 0.0005 mass % or more, more preferably 0.0008 mass % or more, further preferably 0.001 mass % or more, furthermore preferably 0.002 mass % or more, furthermore preferably 0.1 mass % or more, furthermore preferably 0.5 masse or more, furthermore preferably 1 mass % or more, furthermore preferably 2 mass % or more and furthermore preferably 3 mass % or more, and preferably 20 mass % or less, more preferably 15 mass % or less, further preferably 10 mass % or less and furthermore preferably 5 mass % or less from the viewpoints of protein washing performance and formulation in consideration of workability.

When the third detergent composition for use in an automatic dishwasher of the present invention is a formulation that can be used as-is without dilution (thin formulation), it can contain component (e) in an amount of, for example, preferably 0.0005 mass % or more, more preferably 0.0008 mass % or more, further preferably 0.001 mass % or more and furthermore preferably 0.002 mass % or more, and preferably 0.05 mass % or less, more preferably 0.02 mass % or less, further preferably 0.01 mass % or less and furthermore preferably 0.005 mass % or less from the viewpoint of protein washing performance. Note that even if the concentration of a formulation falls within this range, the formulation may also be used after dilution.

When the third detergent composition for use in an automatic dishwasher of the present invention is a formulation that can be used after dilution (thick formulation), it can contain component (e) in an amount of, for example, preferably 0.1 mass % or more, more preferably 0.5 mass % or more, further preferably 1 mass % or more, furthermore preferably 2 mass % or more and furthermore preferably 3 mass % or more, and preferably 20 mass % or less, more preferably 15 mass % or less, further preferably 10 mass % or less and furthermore preferably 5 mass % or less from the viewpoint of protein washing performance. Note that even if the concentration of a formulation falls within this range, the formulation may also be used without dilution.

In the third detergent composition for use in an automatic dishwasher of the present invention, a mass ratio of a content of component (a) to a content of component (e), (a)/(e), is preferably 0.1 or more, more preferably 0.3 or more, further preferably 0.5 or more, furthermore preferably 1 or more and furthermore preferably 1.5 or more, and preferably 20 or less, more preferably 10 or less, further preferably 5 or less and furthermore preferably 3 or less from the viewpoint of protein washing performance.

The third detergent composition for use in an automatic dishwasher of the present invention can further contain one or more selected from an alkanolamine, a silicate and a carbonate as component (f) from the viewpoint of washing power for protein soil.

Examples of an alkanolamine include one or more selected from monoethanolamine, diethanolamine, triethanolamine, N-methyl monoethanolamine, N-methyl diethanolamine and N, N-dimethylmonoethanolamine.

Examples of a silicate include one or more selected from sodium silicate and potassium silicate, and more specific examples include one or more selected from sodium metasilicate, sodium orthosilicate, No. 1 sodium silicate, No. 2 sodium silicate, No. 3 sodium silicate, No. 4 sodium silicate, 1K potassium silicate and 2K potassium silicate.

Examples of a carbonate include one or more selected from sodium carbonate, potassium carbonate, lithium carbonate and magnesium carbonate.

Component (f) is preferably one or more selected from monoethanolamine, sodium silicate, potassium silicate, sodium carbonate and potassium carbonate and further preferably one or more selected from monoethanolamine, sodium silicate and potassium carbonate from the viewpoint of protein washing performance.

The third detergent composition for use in an automatic dishwasher of the present invention can contain component (f) in an amount of preferably 0.0001 mass % or more, more preferably 0.0005 mass % or more, further preferably 0.001 mass % or more, furthermore preferably 0.0015 mass % or more, furthermore preferably 0.1 mass % or more, furthermore preferably 0.5 mass % or more, furthermore preferably 1 mass % or more and furthermore preferably 1.5 mass % or more, and preferably 30 mass % or less, more preferably 20 mass % or less, further preferably 15 mass % or less and furthermore preferably 10 mass % or less from the viewpoints of protein washing performance and formulation in consideration of workability.

When the third detergent composition for use in an automatic dishwasher of the present invention is a formulation that can be used as-is without dilution (thin formulation), it can contain component (f) in an amount of, for example, preferably 0.0001 mass % or more, more preferably 0.0005 mass % or more, further preferably 0.001 mass % or more and furthermore preferably 0.0015 mass % or more, and preferably 0.03 mass % or less, more preferably 0.02 mass % or less, further preferably 0.015 mass % or less and furthermore preferably 0.01 mass % or less from the viewpoint of protein washing performance. Note that even if the concentration of a formulation falls within this range, the formulation may also be used after dilution.

When the third detergent composition for use in an automatic dishwasher of the present invention is a formulation that can be used after dilution (thick formulation), it can contain component (f) in an amount of, for example, preferably 0.1 mass % or more, more preferably 0.5 mass % or more, further preferably 1 mass % or more and furthermore preferably 1.5 mass % or more, and preferably 30 mass % or less, more preferably 20 mass % or less, further preferably 15 mass % or less and furthermore preferably 10 mass % or less from the viewpoint of protein washing performance. Note that even if the concentration of a formulation falls within this range, the formulation may also be used without dilution.

In the third detergent composition for use in an automatic dishwasher of the present invention, a mass ratio of a content of component (a) to a content of component (f), (a)/(f), is preferably 0.1 or more, more preferably 0.5 or more, further preferably 1 or more, furthermore preferably 1.5 or more, furthermore preferably 3 or more and furthermore preferably 4 or more, and preferably 50 or less, more preferably 30 or less, further preferably 20 or less, furthermore preferably 10 or less and furthermore preferably 7 or less from the viewpoint of protein washing performance.

The third detergent composition for use in an automatic dishwasher of the present invention can further contain a chelating agent as component (b) from the viewpoint of protein washing performance.

Component (b) is preferably a chelating agent with a calcium stability constant pKCa of 2 or more at a pH of 11 and 25° C. from the viewpoint of protein washing performance. A calcium stability constant pKCa of component (b) is preferably 2 or more, more preferably 2.5 or more and further preferably 3 or more from the viewpoint of washing power for protein soil, and preferably 15 or less, more preferably 10 or less and further preferably 6 or less from the viewpoint of availability.

As a calcium stability constant pKCa, a value measured by the method below is used.

A calcium chloride solution at 25° C. and 2 g/L was added dropwise into 100 mL of distilled water at 25° C. by an amount of 0.2 mL, the potential at that time was measured with a calcium ion-selective electrode (for example, manufactured by HORIBA, Ltd.), and the equation for the first-order approximation was obtained with the logarithm of the calcium ion concentration for each dropwise-addition amount as the horizontal axis and the potential as the vertical axis. Subsequently, distilled water was added to component (b) such that the concentration was conditioned to 1 g/L, and the pH was adjusted to 11 with 1N sodium hydroxide and/or 1N hydrochloric acid, thereby preparing a chelating agent solution. 100 mL of the chelating agent solution was taken out and conditioned to 25° C., 3 mL of a calcium chloride solution at 25° C. and 2 g/L was added dropwise thereto, and the potential was measured with a calcium ion-selective electrode (for example, manufactured by HORIBA, Ltd.). The potential at that time was substituted into the approximation equation to determine concentration A of uncaptured calcium in the chelating agent solution (mol/L), and it was substituted into the formula below together with concentration B of the chelating agent (mol/L), thereby determining KCa to give the logarithm as pKCa.

KCa=(5.4×10⁻⁵−A)/(A×(B−(5.4×10⁻⁵−A)))

Specific examples of component (b) include one or more selected from ethylenediaminetetraacetic acid (pKCa 12.2), tripolyphosphoric acid (pKCa 5.9), a polyacrylic acid (pKCa 3.2), an acrylic acid-maleic acid copolymer (pKCa about 3.5 (which can vary depending on the monomer ratio)), citric acid (pKCa 3.2), glutamic acid diacetic acid (pKCa 6.5), methylglycinediacetic acid (pKCa 6.3), L-aspartic acid N, N-diacetic acid (pKCa 7.0) and salts of these, and from the viewpoint of protein washing performance, one or more selected from ethylenediaminetetraacetic acid, a polyacrylic acid, an acrylic acid-maleic acid copolymer, citric acid, methylglycinediacetic acid and salts of these are preferable, and one or more selected from a polyacrylic acid, citric acid, methylglycinediacetic acid and salts of these are more preferable. Examples of the salts include alkali metal salts such as sodium salts, potassium salts or the like, ammonium salts or alkanolamine salts such as monoethanolamine salts, triethanolamine salts or the like, and potassium salts or sodium salts are preferable from the viewpoint of availability.

A polyacrylic acid or a salt thereof of component (b) is the same as in the aspect described in component (b) of the first detergent composition for use in an automatic dishwasher of the present invention.

An acrylic acid-maleic acid copolymer or a salt thereof of component (b) is the same as in the aspect described in component (b) of the first detergent composition for use in an automatic dishwasher of the present invention.

The third detergent composition for use in an automatic dishwasher of the present invention can contain component (b) in an amount of preferably 0.0001 mass % or more, more preferably 0.0005 mass % or more, further preferably 0.001 mass % or more, furthermore preferably 0.002 mass % or more, furthermore preferably 0.1 mass % or more, furthermore preferably 0.5 mass % or more, furthermore preferably 1 mass % or more and furthermore preferably 2 mass % or more, and preferably 50 mass % or less, more preferably 25 mass % or less, further preferably 15 mass % or less and furthermore preferably 10 mass % or less from the viewpoints of protein washing performance and formulation in consideration of workability.

When the third detergent composition for use in an automatic dishwasher of the present invention is a formulation that can be used as-is without dilution (thin formulation), it can contain component (b) in an amount of, for example, preferably 0.0001 mass % or more, more preferably 0.0005 mass % or more, further preferably 0.001 mass % or more and furthermore preferably 0.002 mass % or more, and preferably 0.05 mass % or less, more preferably 0.025 mass % or less, further preferably 0.015 mass % or less and furthermore preferably 0.01 mass % or less from the viewpoint of protein washing performance. Note that even if the concentration of a formulation falls within this range, the formulation may also be used after dilution.

When the third detergent composition for use in an automatic dishwasher of the present invention is a formulation that can be used after dilution (thick formulation), it can contain component (b) in an amount of, for example, preferably 0.1 mass % or more, more preferably 0.5 mass % or more, further preferably 1 mass % or more and furthermore preferably 2 mass % or more, and preferably 50 mass % or less, more preferably 25 mass % or less, further preferably 15 mass % or less and furthermore preferably 10 mass % or less from the viewpoint of protein washing performance. Note that even if the concentration of a formulation falls within this range, the formulation may also be used without dilution.

Note that, in the present invention, a value calculated by assuming that component (b) is a sodium salt is used for the specification relating to the mass of component (b).

In the third detergent composition for use in an automatic dishwasher of the present invention, a mass ratio of a content of component (a) to a content of component (b), (a)/(b), is preferably 0.01 or more, more preferably 0.1 or more, further preferably 0.5 or more and furthermore preferably 1 or more, and preferably 50 or less, more preferably 30 or less, further preferably 20 or less, furthermore preferably 10 or less, furthermore preferably 5 or less and furthermore preferably 3 or less from the viewpoint of protein washing performance.

The third detergent composition for use in an automatic dishwasher of the present invention can further contain a surfactant as component (g) from the viewpoints of protein washing performance, oil washing performance and anti-foaming performance.

A surfactant of component (g) is preferably a nonionic surfactant from the viewpoints of protein washing performance, oil washing performance and anti-foaming performance.

Examples of a nonionic surfactant of component (g) include a polyoxyalkylene alkyl ether, a polyoxyalkylene alkenyl ether, a polyoxyalkylene sorbitan fatty acid ester, an alkyl glycoside, an alkyl polyglycoside, a sucrose fatty acid ester, an alkyl polyglyceryl ether or the like, and one or two or more of these can be used. These nonionic surfactants have an alkyl group or an alkenyl group with preferably 6 or more and more preferably 8 or more, and preferably 22 or less and more preferably 18 or less carbons from the viewpoint of protein washing performance. An alkylene oxide of a polyoxyalkylene alkyl ether, a polyoxyalkylene alkenyl ether or a polyoxyalkylene sorbitan fatty acid ester preferably includes an alkylene oxide selected from ethylene oxide and propylene oxide from the viewpoint of protein washing performance, and an average number of added moles of an alkylene oxide is preferably 2 or more and preferably 25 or less from the viewpoint of protein washing performance.

Component (g) is preferably a polyoxyalkylene alkyl ether [hereinafter referred to as component (g1)]. An alkyl group in component (g1) has preferably 10 or more and more preferably 12 or more, and preferably 20 or less, more preferably 18 or less and further preferably 16 or less carbons from the viewpoint of protein washing performance. An alkylene oxide in component (g1) preferably includes an alkylene oxide selected from ethylene oxide and propylene oxide from the viewpoint of protein washing performance. Further, an average number of added moles of an alkylene oxide in component (g1) is preferably 2 or more and more preferably 4 or more, and preferably 20 or less and more preferably 18 or less from the viewpoint of protein washing performance.

Examples of component (g1) include a secondary alcohol alkylene oxide adduct with 10 or more and 24 or less carbons. The secondary alcohol has preferably 10 or more and more preferably 12 or more, and preferably 20 or less, more preferably 18 or less and further preferably 16 or less carbons from the viewpoint of protein washing performance. Examples include a primary alcohol alkylene oxide adduct with 10 or more and 24 or less carbons. The primary alcohol has preferably 10 or more and more preferably 12 or more, and preferably 20 or less, more preferably 18 or less and further preferably 16 or less carbons from the viewpoint of protein washing performance. An alkylene oxide is preferably an alkylene oxide with 2 or more and 4 or less carbons from the viewpoint of protein washing performance. An alkylene oxide preferably includes an alkylene oxide selected from ethylene oxide and propylene oxide from the viewpoint of protein washing performance. An average number of added moles of an alkylene oxide is preferably 2 or more and more preferably 4 or more, and preferably 20 or less and more preferably 18 or less from the viewpoint of protein washing performance.

The third detergent composition for use in an automatic dishwasher of the present invention can contain component (g) in an amount of preferably 0.00001 mass % or more, more preferably 0.0001 mass % or more, further preferably 0.0005 mass % or more, furthermore preferably 0.001 mass % or more, furthermore preferably 0.01 mass % or more, furthermore preferably 0.1 mass % or more, furthermore preferably 0.5 mass % or more and furthermore preferably 1.0 mass % or more, and preferably 20 mass % or less, more preferably 15 mass % or less, further preferably 10 mass % or less and furthermore preferably 5 mass % or less from the viewpoints of protein washing performance, oil washing performance, formulation in consideration of workability and anti-foaming performance.

When the third detergent composition for use in an automatic dishwasher of the present invention is a formulation that can be used as-is without dilution (thin formulation), it can contain component (g) in an amount of, for example, preferably 0.00001 mass % or more, more preferably 0.0001 mass % or more, further preferably 0.0005 mass % or more and furthermore preferably 0.001 mass % or more, and preferably 0.02 mass % or less, more preferably 0.015 mass % or less, further preferably 0.01 mass % or less and furthermore preferably 0.005 mass % or less from the viewpoints of protein washing performance, oil washing performance and anti-foaming performance. Note that even if the concentration of a formulation falls within this range, the formulation may also be used after dilution.

When the third detergent composition for use in an automatic dishwasher of the present invention is a formulation that can be used after dilution (thick formulation), it can contain component (g) in an amount of, for example, preferably 0.01 mass % or more, more preferably 0.1 mass % or more, further preferably 0.5 mass % or more and furthermore preferably 1.0 mass % or more, and preferably 20 mass % or less, more preferably 15 mass % or less, further preferably 10 mass % or less and furthermore preferably 5 mass % or less from the viewpoints of protein washing performance, oil washing performance and anti-foaming performance. Note that even if the concentration of a formulation falls within this range, the formulation may also be used without dilution.

In the third detergent composition for use in an automatic dishwasher of the present invention, the ranges of the contents of components (a), (e), (f), (b) and (g) can each be set by arbitrarily selecting numerical values from the above and combining them.

A pH of the third detergent composition for use in an automatic dishwasher of the present invention at 25° C. is more than 11, preferably 11.5 or more and more preferably 12 or more, and 14 or less from the viewpoint of protein washing performance. A method for measuring this pH is the same as the pH measurement method described in the first detergent composition for use in an automatic dishwasher of the present invention.

A pH at 25° C. of a diluted product of the third detergent composition for use in an automatic dishwasher of the present invention diluted with water at a concentration of 0.1 mass % is preferably 9 or more and more preferably 10 or more, and preferably 12 or less and more preferably 11 or less from the viewpoints of protein washing performance and human safety. This pH is measured by the measurement method described in the first detergent composition for use in an automatic dishwasher of the present invention (provided that the detergent composition for use in an automatic dishwasher is read as the diluted product of the detergent composition for use in an automatic dishwasher).

The third detergent composition for use in an automatic dishwasher of the present invention preferably contains water from the viewpoints of the stability of the composition and workability. Examples of water are not particularly limited to, but include tap water, well water, ion exchange water, distilled water or the like. This water is preferably used in an amount of the balance of the composition (an amount making the total 100 mass %). A content of water in the composition can be, for example, 40 mass % or more, further 45 mass % or more, further 50 mass % or more, further 55 mass % or more, further 60 mass % or more, further 65 mass % or more and further 70 mass % or more.

The third detergent composition for use in an automatic dishwasher of the present invention can be formulated with components such as an enzyme (a proteolytic enzyme, a lipolytic enzyme, a glycolytic enzyme or the like), a solvent, a hydrotropic agent, a dispersant, a pH adjuster, a thickener, a viscosity adjuster, a fragrance, a colorant, an anti-oxidant, an antiseptic, an anti-foaming agent, a bleaching agent, a bleach activator or the like (excluding those qualifying for components (a), (e), (f), (b) and (g)) in the range that the purpose of the present invention is not impaired.

A viscosity of the third detergent composition for use in an automatic dishwasher of the present invention at 20° ° C. may be, for example, 1200 mPa·s or less and further 1000 mPa·s or less from the viewpoint of protein washing performance. A lower limit of the viscosity may be 0 mPa·s or more. This viscosity is measured with a B-type viscometer.

In the present invention, tableware is the same as described in the first detergent composition for use in an automatic dishwasher of the present invention.

### <Third Method for Washing Tableware>

The present invention provides a third method for washing tableware including, washing, by using an automatic dishwasher, tableware adhered with soil containing protein with a washing liquid prepared by diluting the third detergent composition for use in an automatic dishwasher of the present invention with water (hereinafter referred to as a third washing liquid of the present invention).

The matters stated in the third detergent composition for use in an automatic dishwasher of the present invention can be appropriately applied to the third method for washing tableware of the present invention. The specific examples or preferable examples of component (a), component (e), component (f), component (b), component (g), each mass ratio, pH and tableware are also the same as those in the third detergent composition for use in an automatic dishwasher of the present invention.

The third washing liquid of the present invention may be prepared by diluting the third detergent composition for use in an automatic dishwasher of the present invention with water by a factor of more than one and further 300 or more, and 2000 or less and further 1500 or less.

The third washing liquid of the present invention can contain component (a) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more, and preferably 5 mass % or less, more preferably 1 mass % or less, further preferably 0.5 mass % or less, furthermore preferably 0.1 mass % or less and furthermore preferably 0.05 mass % or less from the viewpoints of protein washing performance and maintained protein washing performance.

The third washing liquid of the present invention can contain component (e) in an amount of, for example, preferably 0.0005 mass % or more, more preferably 0.0008 mass % or more, further preferably 0.001 mass % or more and furthermore preferably 0.002 mass % or more, and preferably 0.05 mass % or less, more preferably 0.02 mass % or less, further preferably 0.01 mass % or less and furthermore preferably 0.005 mass % or less from the viewpoint of protein washing performance.

The third washing liquid of the present invention can contain component (f) in an amount of, for example, preferably 0.0001 mass % or more, more preferably 0.0005 mass % or more, further preferably 0.001 mass % or more and furthermore preferably 0.0015 mass % or more, and preferably 0.03 mass % or less, more preferably 0.02 mass % or less, further preferably 0.015 mass % or less and furthermore preferably 0.01 mass % or less from the viewpoint of protein washing performance.

The third washing liquid of the present invention can contain component (b) in an amount of, for example, preferably 0.0001 mass % or more, more preferably 0.0005 mass % or more, further preferably 0.001 mass % or more and furthermore preferably 0.002 mass % or more, and preferably 0.05 mass % or less, more preferably 0.025 mass % or less, further preferably 0.015 mass % or less and furthermore preferably 0.01 mass % or less from the viewpoint of protein washing performance.

The third washing liquid of the present invention can contain component (g) in an amount of, for example, preferably 0.00001 mass % or more, more preferably 0.0001 mass % or more, further preferably 0.0005 mass % or more and furthermore preferably 0.001 mass % or more, and preferably 0.02 mass % or less, more preferably 0.015 mass % or less, further preferably 0.01 mass % or less and furthermore preferably 0.005 mass % or less from the viewpoints of protein washing performance, oil washing performance and anti-foaming performance.

The ranges of the contents of components (a), (e), (f), (b) and (g) in the third washing liquid of the present invention can each be set by arbitrarily selecting numerical values from the above and combining them.

A pH of the third washing liquid of the present invention is preferably 9 or more, more preferably 9.5 or more and further preferably 10 or more, and preferably 12 or less, more preferably 11.5 or less and further preferably 11 or less from the viewpoints of protein washing performance and human safety.

In the third method for washing tableware of the present invention, the third washing liquid is brought into contact with the tableware for, for example, 20 seconds or more, further 30 seconds or more and further 40 seconds or more, and 600 seconds or less, further 300 seconds or less and further 180 seconds or less from the viewpoint of protein washing performance.

In the third method for washing tableware of the present invention, a temperature of the washing liquid can be, for example, 30° C. or more, further 35° C. or more and further 40° C. or more, and 90° ° C. or less, further 80° C. or less and further 70° ° C. or less.

In the third method for washing tableware of the present invention, a flow rate when the third washing liquid is brought into contact with the tableware can be preferably 5 m/min or more, more preferably 10 m/min or more and further preferably 50 m/min or more, and preferably 2000 m/min or less, more preferably 1000 m/min or less and more preferably 500 m/min or less from the viewpoint of protein washing performance.

The soil containing protein may be soil containing protein derived from egg yolk.

After the third washing liquid is brought into contact with the tableware, the tableware is rinsed with water. A temperature of water for rinsing the tableware is 50° C. or more, preferably 55° C. or more and more preferably 60° C. or more, and 80° C. or less.

A time for rinsing the tableware is 4 seconds or more and preferably 5 seconds or more, and 10 seconds or less and preferably 9 seconds or less.

A flow rate of rinsing water is preferably 5 m/min or more, more preferably 10 m/min or more and further preferably 100 m/min or more, and preferably 2500 m/min or less, more preferably 2000 m/min or less and further preferably 1500 m/min or less.

In the present invention, an automatic dishwasher is the same as described in the first detergent composition for use in an automatic dishwasher and the first method for washing tableware of the present invention.

In the third method for washing tableware of the present invention, the washing liquid after washing tableware may be collected in a tank, and the collected washing liquid may be reused for washing tableware.

In the case where a washing liquid after washing tableware is collected in a tank and reused as a washing liquid for tableware, the washing liquid is mixed with soil adhering to tableware or diluted with rinsing water to have a liquid property in the region of neutrality to weak alkalinity, being less likely to remove soil containing protein, but the third washing liquid of the present invention can remove soil containing protein even if having a liquid property in the region of neutrality to weak alkalinity.

### [Fourth Method for Washing Hard Surface]

It is not wholly certain why the fourth method for washing a hard surface of the present invention can achieve effective washing of soil containing protein adhering to a hard surface even if a liquid property is in the region of neutrality to weak alkalinity, but it is inferred to be as follows.

As a result of analyzing protein soil difficult to wash such as dried egg yolk soil or the like, the present inventors found that, as disulfide bonds (—SS— bonds) within protein molecules or between molecules in a protein structure stabilize the structure, swelling or dispersion is less likely to occur with an existing detergent basically composed of a surfactant in a washing process carried out in the region of neutrality to weak alkalinity. It is considered in the present invention that when 20% or more of disulfide bonds in protein constituting protein soil difficult to wash is cleaved, the swelling of protein by a washing liquid occurs even if a liquid property of the washing liquid is in the region of neutrality to weak alkalinity, and with the application of physical force such as collision of the washing liquid or the like, washing can be easily achieved. A method for cleaving disulfide bonds in protein when a liquid property of a washing liquid is in the region of neutrality to weak alkalinity is not particularly limited to, and may include, for example, a reduction reaction with a reducing agent or an enzyme, but in particular, when a reducing agent with an oxidation-reduction potential equal to or less than +71 mV which is an oxidation-reduction potential of disulfide bonds is used, the cleavage of disulfide bonds in protein easily proceeds. Further, it was also found in an investigation process for the present invention that a protein structure stabilizes the structure by cross-linking structures made of anionic groups and calcium ions in protein, for example, phosphoric acid-Ca cross-linking structures that phosphoric acid groups of protein molecules form via Ca ions within protein molecules or between molecules, and it is considered that, if phosphoric acid-Ca cross-linking structures are cleaved by using a chelating agent with a dissociation constant equal to or more than that of phosphoric acid/Ca for the cleavage of disulfide bonds, disulfide bonds can be more easily cleaved.

Note that the acting mechanism by which the present invention exhibits its effect is not limited to the above.

The present invention provides a fourth method for washing a hard surface including, bringing a washing liquid at a pH of 6 or more and 11 or less (hereinafter referred to as a fourth washing liquid of the present invention) into contact with a hard surface adhered with soil containing protein such that a cleavage rate of disulfide bonds in protein molecules or between proteins is 20% or more and 100% or less.

In the fourth method for washing a hard surface of the present invention, the fourth washing liquid of the present invention is brought into contact with the hard surface adhered with soil containing protein such that a cleavage rate of disulfide bonds in protein molecules or between proteins is 208 or more, preferably 30% or more and more preferably 40% or more, and 100% or less from the viewpoint of protein washing performance.

A cleavage rate of disulfide bonds in protein molecules or between proteins in soil containing protein is measured by the method below.

4 (Aminosulfonyl)-7-fluoro-2,1,3-benzoxadiazole (ABD-F, for example, manufactured by Tokyo Chemical Industry Co., Ltd.) is added to a 0.1 M borate buffer at a pH of 8 to prepare a 100 μM ABD-F solution (hereinafter referred to as liquid (A)). Disodium ethylenediaminetetraacetate (EDTA2Na) is added to a 0.1 M borate buffer at a pH of 8 to prepare a 1 mM EDTA2Na solution, into which a target soil containing protein having disulfide bonds (for example, egg yolk) is added at 1000 ppm, and a target agent for cleaving disulfide bonds contained in the washing liquid of the present invention is added such that it is in an amount twice the concentration in the washing liquid to prepare liquid (B). Liquids (A) and (B) are placed in an Eppendorf tube in an amount of 500 μL each and mixed together. The mixed liquid is heated with a block heater (for example, WSC-2620 manufactured by ATTO CORPORATION) at 50° ° C. for 5 minutes, and then cooled with ice water for 10 minutes. After cooling, 300 μL of 0.1 M hydrochloric acid is added to the mixed liquid. 200 μL of the mixed liquid is placed in a 96-well plate and subjected to fluorometric measurements with a fluorometer (for example, SH-9000 manufactured by Corona Electric Co., Ltd.) (excitation wavelength/measurement wavelength=389/513 nm, measurement sensitivity×100).

Next, the target soil containing protein having disulfide bonds is added at 1000 ppm to an aqueous NaOH solution whose pH is adjusted to 11 to prepare liquid (B), liquid (B) is mixed with the above liquid (A) to prepare a mixed liquid using NaOH as an agent for cleaving disulfide bonds, and fluorometric measurements are made in the same manner as above.

Next, liquid (B) is prepared in the same manner as above except that, during the preparation of liquid (B), glutathione (for example, manufactured by FUJIFILM Wako Pure Chemical Corporation), a simple compound having disulfide bonds, is added at varying concentrations instead of the target soil containing protein having disulfide bonds, and sodium sulfite is added at 1000 ppm as an agent for cleaving disulfide bonds, liquid (B) is mixed with the above liquid (A) to prepare mixed liquids at varying glutathione concentrations, fluorometric measurements are made in the same manner as above, and a calibrate curve of the glutathione concentration and the fluorescence intensity is prepared.

The amount of disulfide bonds cleaved by an agent for cleaving disulfide bonds is estimated from this calibration curve and the fluorometric measurement result for the soil containing protein having disulfide bonds when the agent for cleaving disulfide bonds is used, and with the fluorometric measurement result when NaOH is used as an agent for cleaving disulfide bonds as a disulfide bond cleavage rate of 100%, the disulfide bond cleavage rate by each agent for cleaving disulfide bonds is calculated.

While examples of a method for achieving a cleavage rate of disulfide bonds in protein molecules or between proteins in soil containing protein of 20% or more and 100% or less are not particularly limited to, but include, causing a reaction such as an oxidation-reduction reaction using a reducing agent or a disulfide oxidoreductase, a thiol-disulfide exchange reaction through a reaction with a low-molecular-weight thiol compound, a disulfide-disulfide exchange reaction with a low-molecular-weight disulfide compound or the like, and others, a method using a washing liquid containing a reducing agent and/or a disulfide oxidoreductase is preferable, and a method using a washing liquid containing a reducing agent is more preferable from the viewpoints of a short-time washing process, a temperature region, workability and availability of chemicals used or the like.

From the viewpoint of protein washing performance, the fourth washing liquid of the present invention can contain the following component (a),
component (a): a reducing agent with an oxidation-reduction potential of +71 mV or less.

Component (a) is the same as in the aspect of component (a) described in the first detergent composition for use in an automatic dishwasher of the present invention.

Component (a) is not particularly limited as long as it has an oxidation-reduction potential of +71 mV or less, but is one or more selected from preferably sodium sulfite, sodium disulfate, potassium iodide and sodium thiosulfate and more preferably sodium sulfite, sodium disulfate and potassium iodide from the viewpoint of protein washing performance.

The fourth washing liquid of the present invention can contain component (a) in an amount of, for example, preferably 0.0001 mass % or more, more preferably 0.0005 mass % or more, further preferably 0.001 mass % or more, furthermore preferably 0.002 mass % or more and furthermore preferably 0.005 mass % or more from the viewpoint of protein washing performance, and preferably 30 mass % or less, more preferably 20 mass % or less, further preferably 10 mass % or less, furthermore preferably 8 mass % or less, furthermore preferably 5 mass % or less, furthermore preferably 1 mass % or less, furthermore preferably 0.5 mass % or less, furthermore preferably 0.1 mass % or less and furthermore preferably 0.5 mass % or less from the viewpoints of protein washing performance and the stability of properties as a formulation.

From the viewpoint of protein washing performance, the fourth washing liquid of the present invention can contain the following component (b),
component (b): a chelating agent.

Component (b) is preferably a chelating agent with a conditional calcium stability constant pK′Ca of 2.6 or more at a pH of 7.5 and 60° C. from the viewpoint of protein washing performance.

A conditional calcium stability constant pK′Ca of component (b) at a pH of 7.5 and 60° C. is preferably 2.6 or more and more preferably 2.7 or more from the viewpoint of protein washing performance, further preferably 3 or more and furthermore preferably 3.2 or more from the viewpoint of protein washing performance, and preferably 15 or less, more preferably 10 or less and further preferably 6 or less from the viewpoint of availability.

A method for measuring a conditional calcium stability constant pK′Ca of component (b) at a pH of 7.5 and 60° C. is the same as the measurement method described for a conditional calcium stability constant pK′Ca of component (b) at a pH of 7.5 and 60° ° C. in the first detergent composition for use in an automatic dishwasher of the present invention.

Specific examples of component (b) include one or more selected from ethylenediaminetetraacetic acid (pK′Ca 6.0), hexametaphosphoric acid (pK′Ca 5.7), a polyacrylic acid (pK′Ca 4.2), an acrylic acid-maleic acid copolymer (pK′Ca about 4.6 (which can vary depending on the monomer ratio)), citric acid (pK′Ca 3.4), tripolyphosphoric acid (pk′Ca 3.8), nitrilotriacetic acid (pk′Ca 2.9), a glutamate diacetate salt (pK′Ca 2.7) and salts of these, and from the viewpoint of protein washing performance, one or more selected from ethylenediaminetetraacetic acid, hexametaphosphoric acid, a polyacrylic acid, an acrylic acid-maleic acid copolymer, citric acid, tripolyphosphoric acid, nitrilotriacetic acid, a glutamate diacetate salt and salts of these are preferable, one or more selected from ethylenediaminetetraacetic acid, hexametaphosphoric acid, a polyacrylic acid, an acrylic acid-maleic acid copolymer, citric acid and salts of these are more preferable, and one or more selected from a polyacrylic acid, citric acid and salts of these are further preferable. Examples of the salts include alkali metal salts such as sodium salts, potassium salts or the like, ammonium salts or alkanolamine salts such as monoethanolamine salts, triethanolamine salts or the like, and potassium salts or sodium salts are preferable from the viewpoint of availability.

A polyacrylic acid or a salt thereof of component (b) is the same as in the aspect described in component (b) of the first detergent composition for use in an automatic dishwasher of the present invention.

An acrylic acid-maleic acid copolymer or a salt thereof of component (b) is the same as in the aspect described in component (b) of the first detergent composition for use in an automatic dishwasher of the present invention.

The fourth washing liquid of the present invention can contain component (b) in an amount of preferably 0.0001 mass % or more, more preferably 0.0005 mass % or more, further preferably 0.001 mass % or more, furthermore preferably 0.002 mass % or more, furthermore preferably 0.005 mass % or more and furthermore preferably 0.01 mass % or more, and preferably 10 mass % or less, more preferably 5 mass % or less, further preferably 3 mass % or less, furthermore preferably 1 mass % or less, furthermore preferably 0.5 mass % or less, furthermore preferably 0.1 mass % or less and furthermore preferably 0.05 mass % or less from the viewpoint of protein washing performance.

In the fourth washing liquid of the present invention, a mass ratio of a content of component (a) to a content of component (b), (a)/(b), is preferably 0.05 or more, more preferably 0.1 or more, further preferably 0.15 or more, furthermore preferably 0.2 or more and furthermore preferably 0.3 or more, and preferably 3.0 or less, more preferably 2.5 or less, further preferably 2 or less, furthermore preferably 1.5 or less and furthermore preferably 1 or less from the viewpoint of protein washing performance.

From the viewpoint of protein washing performance, the washing liquid of the present invention can contain the following component (c),
component (c): an anionic surfactant.

Component (c) is the same as component (c) described in the second detergent composition for use in an automatic dishwasher of the present invention, and the preferable aspects thereof are also the same.

The fourth washing liquid of the present invention can contain component (c) in an amount of preferably 0.0001 mass % or more, more preferably 0.0005 mass % or more, further preferably 0.001 mass % or more, furthermore preferably 0.002 mass % or more and furthermore preferably 0.005 mass % or more, and preferably 20 mass % or less, furthermore preferably 10 mass % or less, further preferably 5 mass % or less, furthermore preferably 1 mass % or less, furthermore preferably 0.5 mass % or less, furthermore preferably 0.1 mass % or less and furthermore preferably 0.05 mass % or less from the viewpoint of protein washing performance.

In the fourth washing liquid of the present invention, a mass ratio of a content of component (a) to a content of component (c), (a)/(c), is preferably 0.01 or more, more preferably 0.05 or more, further preferably 0.08 or more, furthermore preferably 0.1 or more and furthermore preferably 0.5 or more, and preferably 10 or less, more preferably 6 or less, further preferably 4 or less and furthermore preferably 2 or less from the viewpoint of protein washing performance.

From the viewpoints of protein washing performance, oil washing performance and finishing performance for washed articles, the fourth washing liquid of the present invention can contain the following component (d),
component (d): a nonionic surfactant.

Component (d) is the same as component (d) described in the first detergent composition for use in an automatic dishwasher of the present invention, and the preferable aspects thereof are also the same.

The fourth washing liquid of the present invention can contain component (d) in an amount of preferably 0.00001 mass % or more, more preferably 0.0001 mass % or more, further preferably 0.0005 mass % or more, furthermore preferably 0.001 mass % or more and furthermore preferably 0.005 mass % or more, and preferably 10 mass % or less, more preferably 8 mass % or less, further preferably 5 mass % or less, furthermore preferably 1 mass % or less, furthermore preferably 0.5 mass % or less, furthermore preferably 0.1 mass % or less, furthermore preferably 0.05 mass % or less and furthermore preferably 0.01 mass % or less from the viewpoints of protein washing performance, oil washing performance and finishing performance for washed articles.

In the fourth washing liquid of the present invention, a mass ratio of a content of component (a) to a content of component (d), (a)/(d), is preferably 0.1 or more, more preferably 0.2 or more, further preferably 0.3 or more, furthermore preferably 0.4 or more, furthermore preferably 0.8 or more and furthermore preferably 1.2 or more, and preferably 5 or less, more preferably 4 or less, further preferably 3 or less and furthermore preferably 2 or less from the viewpoints of protein washing performance, oil washing performance and finishing performance for washed articles.

In the fourth washing liquid of the present invention, the ranges of the contents of components (a), (b), (c) and (d) can each be set by arbitrarily selecting numerical values from the above and combining them.

A pH of the fourth washing liquid of the present invention at 25° C. is 6 or more, preferably 6.2 or more and more preferably 6.5 or more, and 11 or less, preferably 10 or less and more preferably 9 or less from the viewpoint of reducing the risk of chemical injuries. A method for measuring this pH is the same as the pH measurement method described in the first detergent composition for use in an automatic dishwasher of the present invention.

The fourth washing liquid of the present invention contains water. Examples of water are not particularly limited to, but include tap water, well water, ion exchange water, distilled water or the like. This water is preferably used in an amount of the balance of the washing liquid (an amount making the total 100 mass %). A content of water in the washing liquid can be, for example, 20 mass % or more, further 30 mass % or more, further 50 mass % or more, further 55 mass % or more, further 60 mass % or more, further 65 mass % or more, further 70 mass % or more, further 80 mass % or more, further 90 mass % or more, further 95 mass % or more and further 99 mass % or more.

The fourth washing liquid of the present invention can be formulated with components such as a surfactant, an enzyme (a proteolytic enzyme, a lipolytic enzyme, a glycolytic enzyme or the like), a solvent, a hydrotropic agent, a dispersant, a pH adjuster, a thickener, a viscosity adjuster, a fragrance, a colorant, an anti-oxidant, an antiseptic, an anti-foaming agent, a bleaching agent, a bleach activator or the like (excluding those qualifying for components (a) to (d)) in the range that the purpose of the present invention is not impaired.

A target to be washed in the fourth method for washing a hard surface of the present invention is preferably tableware and/or a hard article in and around the kitchen, and preferably tableware.

A hard article in and around the kitchen is an article used in and around the kitchen, and specifically,
(1) storage places for food, tableware or cooking utensils, such as a refrigerator, a cupboard or the like,
(2) cooking places for food, such as a drain, a cooking table, a range hood, a sink, a gas range, a microwave oven or the like and
(3) a floor, a wall or the like around the above storage places or the above cooking places. In the present invention, these are referred to as “a hard article in and around the kitchen” for convenience.

Further, specific examples of tableware include members or utensils coming in contact with foodstuffs such as
(i) so-called tableware such as a dish, a bowl or the like,
(ii) storage jars such as Tupperware®, a bottle or the like,
(iii) cooking utensils such as a kitchen knife, a chopping board, a pan, a fry pan, a fish grill or the like and
(iv) cooking appliances such as a food processor, a mixer or the like, and others. In the present invention, these are referred to as “tableware” for convenience.

Further, the fourth method for washing a hard surface of the present invention is preferably directed to an article selected from tableware, storage jars, cooking utensils and cooking appliances, and further, more preferably directed to an article selected from a dish, a bowl, Tupperware®, a bottle, a kitchen knife, a chopping board, a pan, a fry pan, a fish grill, a food processor and a mixer.

Examples of a material of a hard article to which the fourth method for washing a hard surface of the present invention is directed include plastic (including silicone resin or the like), metal, ceramic, wood and a combination of these. Further, the fourth method for washing a hard surface of the present invention can achieve effective washing of soil containing protein, particularly, soil containing protein derived from egg yolk, adhering to these tableware and/or hard articles in and around the kitchen, preferably tableware.

In the fourth method for washing a hard surface of the present invention, the contact of the fourth washing liquid of the present invention with the hard surface is preferably carried out by using an automatic dishwasher.

In the present invention, an automatic dishwasher is the same as described in the first detergent composition for use in an automatic dishwasher and the first method for washing tableware of the present invention.

In the fourth method for washing a hard surface of the present invention, the fourth washing liquid of the present invention is brought into contact with the hard surface for preferably 20 seconds or more, more preferably 30 seconds or more, further preferably 40 seconds or more and furthermore preferably 60 seconds or more from the viewpoint of protein washing performance, and preferably 600 seconds or less, more preferably 300 seconds or less, further preferably 180 seconds or less and furthermore preferably 100 seconds or less from the viewpoint of washing efficiency.

In the fourth method for washing a hard surface of the present invention, a temperature of the fourth washing liquid of the present invention is preferably 30° C. or more, more preferably 35° C. or more, further preferably 40° C. or more and furthermore preferably 50° C. or more, and preferably 80° C. or less, more preferably 70° C. or less and further preferably 65° C. or less from the viewpoint of protein washing performance.

In the fourth method for washing a hard surface of the present invention, a flow rate when the fourth washing liquid is brought into contact with the tableware can be preferably 5 m/min or more, more preferably 10 m/min or more and further preferably 50 m/min or more, and preferably 2000 m/min or less, more preferably 1000 m/min or less, more preferably 500 m/min or less, further preferably 250 m/min or less and furthermore preferably 150 m/min or less from the viewpoint of protein washing performance.

After the fourth washing liquid of the present invention is brought into contact with the hard surface, the hard surface is rinsed with water. A temperature of water for rinsing the hard surface is 50° C. or more, preferably 55° C. or more and more preferably 60° C. or more, and 80° ° C. or less.

A time for rinsing the hard surface is 4 seconds or more and preferably 5 seconds or more, and 10 seconds or less and preferably 9 seconds or less.

A flow rate of rinsing water is preferably 5 m/min or more, more preferably 10 m/min or more and further preferably 100 m/min or more, and preferably 2500 m/min or less, more preferably 2000 m/min or less and further preferably 1500 m/min or less.

### EXAMPLES

### Example a and Comparative Example a

The formulation components used in example a and comparative example a are listed collectively below.

<Component (a)>
Sodium sulfite: oxidation-reduction potential 50 mV, manufactured by FUJIFILM Wako Pure Chemical Corporation
Sodium disulfate: oxidation-reduction potential 17 mV, manufactured by FUJIFILM Wako Pure Chemical Corporation
Sodium thiosulfate: oxidation-reduction potential 5 mV, manufactured by FUJIFILM Wako Pure Chemical Corporation
Potassium iodide: oxidation-reduction potential 28 mV, manufactured by FUJIFILM Wako Pure Chemical Corporation
   <Component (a′) (Comparative Component for Component (a))>
Sodium dithionite: oxidation-reduction potential 76 mV, manufactured by FUJIFILM Wako Pure Chemical Corporation
Thiourea dioxide: oxidation-reduction potential 147 mV, manufactured by FUJIFILM Wako Pure Chemical Corporation

An oxidation-reduction potential of component (a) or (a′) was measured by the method below.

Distilled water was added to component (a) or (a′) such that the concentration was 0.016 mol/L, and 1 mol/L hydrochloric acid and/or sodium hydroxide were added to adjust the pH to 7.5 to prepare a conditioned liquid. The temperature of the conditioned liquid was adjusted to 60° C., and the oxidation-reduction potential was measured with an ORP measuring instrument manufactured by CEM corporation Co., Ltd. (ORP5 PEN ORP meter).

<Component (c1)>
C10AS: sodium decyl sulfate, “EMAL 3F” manufactured by Kao Corporation, low-foaming test 0.5 cm
C10SAS: alkyl (10 carbons) sulfonate sodium salt, “sodium 1-decanesulfonate” manufactured by FUJIFILM Wako Pure Chemical Corporation, low-foaming test 0.5 cm
   <Component (c1′) (Comparative Component for Component (c1))>
C12AS: sodium dodecyl sulfate, “sodium dodecyl sulfate” manufactured by FUJIFILM Wako Pure Chemical Corporation, low-foaming test 4.5 cm
LAS: sodium lauryl benzene sulfonate, NEOPELEX G-25 (manufactured by Kao Corporation), low-foaming test 5.0 cm

In a low-foaming test for component (c1) or (c1′), 100 mL of a 0.05 mass % aqueous solution of component (c1) or (c1′) contained in a beaker was poured into a 200-mL glass graduated cylinder (PYREX®) from a position 5 cm vertically upper than the opening of the graduated cylinder for 5 seconds at an almost constant rate so as not to come in contact with the side surface of the graduated cylinder, and after 30 seconds had passed from pouring, the height of foam was measured.

<Component (b)>
Citric acid: pK′Ca 3.4, manufactured by Showa Kako Corporation
Sodium polyacrylate: sodium polyacrylate, pK′Ca 4.2, molecular weight 17,000, “POIZ 530” manufactured by Kao Corporation

A conditional calcium stability constant pK′Ca of component (b) at a pH of 7.5 and 60° C. was measured by the method below.

A calcium chloride solution at 25° C. and 2 g/L was added dropwise into 100 mL of distilled water at 60° ° C. by an amount of 0.2 mL, the potential at that time was measured with a calcium ion-selective electrode manufactured by HORIBA, Ltd., and the equation for the first-order approximation was obtained with the logarithm of the calcium ion concentration for each dropwise-addition amount as the horizontal axis and the potential as the vertical axis. Subsequently, distilled water was added to component (b) such that the concentration was conditioned to 1 g/L, and the pH was adjusted to 7.5 with 1N sodium hydroxide and/or 1N hydrochloric acid, thereby preparing a chelating agent solution. 100 mL of the chelating agent solution was taken out and heated to 60° C., 3 mL of a calcium chloride solution at 25° C. and 2 g/L was added dropwise thereto, and the potential was measured with a calcium ion-selective electrode manufactured by HORIBA, Ltd. The potential at that time was substituted into the approximation equation to determine concentration A of uncaptured calcium in the chelating agent solution (mol/L), and it was substituted into the formula below together with concentration B of the chelating agent (mol/L), thereby determining K′Ca to give the logarithm as pK′Ca.

K′Ca=(5.4×10⁻⁵−A)/(A×(B−(5.4×10⁻⁵−A)))

<Component (d)>
secC12-14E07P08.5: “SOFTANOL EP7085” manufactured by NIPPON SHOKUBAI CO., LTD., a nonionic surfactant obtained by adding an average of 7 moles of ethylene oxide and an average of 8.5 moles of propylene oxide to a secondary alcohol with 12 to 14 carbons in this order

Using the detergent compositions for use in an automatic dishwasher shown in Table 1, washing power for egg yolk soil was evaluated according to the procedures below. The results are shown in Table 1. Note that adjustments with sodium hydroxide and/or sulfuric acid were made as necessary to obtain the pH of the compositions in Table 1.
(1) The mass of a SUS stainless-steel tray (outer dimensions: width 258 mm×depth 177 mm×height 18 mm, inner dimensions of bottom: 235 mm×155 mm) (mass A) was measured.
(2) The stainless-steel tray was coated with 3 g of egg yolk and dried at room temperature for 3 hours or more.
(3) The mass of the stainless-steel tray after drying (mass B) was measured.
(4) Using JWE-400TA manufactured by HOSHIZAKI CORPORATION as a dishwasher, and each detergent composition for use in an automatic dishwasher in Table 1 diluted with water at 0.2 mass % as a washing liquid, the stainless-steel tray after drying was washed at a temperature of 60° C. for a period of time of 80 seconds at a flow rate of the washing liquid of 100 m/min, and a few seconds later, rinsing was carried out with rinsing water at 80° C. for 7 seconds at a flow rate of rinsing water of 1000 m/min. Note that part of the washing liquid was extracted and the pH at 25° C. was measured.
(5) The mass of the stainless-steel tray after washing (mass C) was measured, and the rate of mass change was evaluated as the egg yolk soil washing rate. The rate of mass change is specifically determined by the following formula:

Rate of mass change (%)={[B−C]/[B−A]}×100

TABLE 1

| | | | | Example a | | | | | | | | | |
|---|---|---|---|---|---|---|---|---|---|---|---|---|---|
| | | | | 1a | 2a | 3a | 4a | 5a | 6a | 7a | 8a | 9a | 10a |
| Detergent | Formulation | (a) | Sodium sulfite | 5 | | | 5 | | 10 | 8 | 3 | 3 | 6 |
| composition | (mass %) | | Sodium disulfate | | 5 | | | | | | | | |
| for use in | | | Potassium iodide | | | 5 | | | | | | | |
| automatic | | | Sodium thiosulfate | | | | | 5 | | | | | |
| dishwasher | | (a′) | Sodium dithionite | | | | | | | | | | |
| | | | Thiourea dioxide | | | | | | | | | | |
| | | (c1) | C10AS | 5 | 5 | 5 | 5 | 5 | 3 | 3 | 8 | 10 | 2 |
| | | | C10SAS | | | | | | | | | | |
| | | (c1′) | C12AS | | | | | | | | | | |
| | | | LAS | | | | | | | | | | |
| | | (b) | Citric acid | 10 | 10 | 10 | | 10 | | | | | |
| | | | Sodium polyacrylate | | | | 10 | | | | | | |
| | | (d) | secC12-14EO7PO8.5 | 3 | 3 | 3 | 3 | 3 | | | 5 | 5 | |

| Water | Bal- | Bal- | Bal- | Bal- | Bal- | Bal- | Bal- | Bal- | Bal- | Bal- |
|---|---|---|---|---|---|---|---|---|---|---|
| | ance | ance | ance | ance | ance | ance | ance | ance | ance | ance |
| Total | 100 | 100 | 100 | 100 | 100 | 100 | 100 | 100 | 100 | 100 |

| | | | | | | | | | | |
|---|---|---|---|---|---|---|---|---|---|---|
| (a)/(c1) (mass ratio) | 1 | 1 | 1 | 1 | 1 | 3.33 | 2.67 | 0.38 | 0.3 | 3 |
| (a)/(b) (mass ratio) | 0.5 | 0.5 | 0.5 | 0.5 | 0.5 | — | — | — | — | — |
| (a) − (c1) (mass %) | 10 | 10 | 10 | 10 | 10 | 13 | 11 | 11 | 13 | 8 |
| pH of raw solution (25° C.) | 7.5 | 7.5 | 7.5 | 7.5 | 7.5 | 7.5 | 7.5 | 7.5 | 7.5 | 7.5 |
| pH of diluted product with water | 7.5 | 7.5 | 7.5 | 7.5 | 7.5 | 7.5 | 7.5 | 7.5 | 7.5 | 7.5 |
| at 0.2 mass % (25° C.) | | | | | | | | | | |
| Oxidation-reduction potential | 50 | 17 | 28 | 50 | 5 | 50 | 50 | 50 | 50 | 50 |
| of (a) or (a′) (mV) | | | | | | | | | | |

| | | | | | | | | | | |
|---|---|---|---|---|---|---|---|---|---|---|
| Egg yolk soil washing rate (%) | 100 | 99 | 94 | 100 | 100 | 100 | 100 | 98 | 100 | 90 |

| | | | | Example a | | | | Comparative example a | | | | |
|---|---|---|---|---|---|---|---|---|---|---|---|---|
| | | | | 11a | 12a | 13a | 14a | 1a | 2a | 3a | 4a | 5a |
| Detergent | Formulation | (a) | Sodium sulfite | 5 | 4 | 1 | 5 | | | 5 | 5 | 5 |
| composition | (mass %) | | Sodium disulfate | | | | | | | | | |
| for use in | | | Potassium iodide | | | | | | | | | |
| automatic | | | Sodium thiosulfate | | | | | | | | | |
| dishwasher | | (a′) | Sodium dithionite | | | | | 5 | | | | |
| | | | Thiourea dioxide | | | | | | 5 | | | |
| | | (c1) | C10AS | 3 | 4 | 7 | | 5 | 5 | | | |
| | | | C10SAS | | | | 5 | | | | | |
| | | (c1′) | C12AS | | | | | | | | | 5 |
| | | | LAS | | | | | | | | 5 | |
| | | (b) | Citric acid | | | | | 10 | 10 | | | |
| | | | Sodium polyacrylate | | | | | | | | | |
| | | (d) | secC12-14EO7PO8.5 | | | | | 3 | 3 | 3 | 3 | 3 |

| Water | Bal- | Bal- | Bal- | Bal- | Bal- | Bal- | Bal- | Bal- | Bal- |
|---|---|---|---|---|---|---|---|---|---|
| | ance | ance | ance | ance | ance | ance | ance | ance | ance |
| Total | 100 | 100 | 100 | 100 | 100 | 100 | 100 | 100 | 100 |

| | | | | | | | | | |
|---|---|---|---|---|---|---|---|---|---|
| (a)/(c1) (mass ratio) | 1.67 | 1 | 0.14 | 1 | 0 | 0 | — | — | — |
| (a)/(b) (mass ratio) | — | — | — | — | — | — | — | — | — |
| (a) − (c1) (mass %) | 8 | 8 | 8 | 10 | — | — | — | — | — |
| pH of raw solution (25° C.) | 7.5 | 7.5 | 7.5 | 7.5 | 7.5 | 7.5 | 7.5 | 7.5 | 7.5 |
| pH of diluted product with water | 7.5 | 7.5 | 7.5 | 7.5 | 7.5 | 7.5 | 7.5 | 7.5 | 7.5 |
| at 0.2 mass % (25° C.) | | | | | | | | | |
| Oxidation-reduction potential | 50 | 50 | 50 | 50 | 76 | 147 | 50 | 50 | 50 |
| of (a) or (a′) (mV) | | | | | | | | | |

| | | | | | | | | | |
|---|---|---|---|---|---|---|---|---|---|
| Egg yolk soil washing rate (%) | 95 | 97 | 97 | 92 | 88 | 87 | 57 | 51 | 63 |

Table 2 shows formulation example a for the detergent composition for use in an automatic dishwasher of the present invention. All the formulation examples can achieve effective washing of soil containing protein by washing with a dishwasher even if a liquid property is in the region of neutrality to weak alkalinity.

TABLE 2

| | | | | Formulation example a | | | | | | |
|---|---|---|---|---|---|---|---|---|---|---|
| | | | | 1a | 2a | 3a | 4a | 5a | 6a | 7a |
| Detergent | Formulation | (a) | Sodium sulfite | 3 | 1 | 5 | 2 | 1 | 3 | 7.5 |
| composition | (mass %) | (c1) | C10AS | 3 | 5 | 1 | 2 | 3 | 1 | 7.5 |
| for use in | | (b) | Citric acid | 5 | 5 | 5 | 5 | 5 | 5 | 5 |
| automatic | | | Sodium polyacrylate | | | | | | | |
| dishwasher | | (d) | secC12-14EO7PO8.5 | 3 | 3 | 3 | 3 | 3 | 3 | 3 |
| | | Water | | Balance | Balance | Balance | Balance | Balance | Balance | Balance |
| | | Total | | 100 | 100 | 100 | 100 | 100 | 100 | 100 |
| | (a)/(c1) (mass ratio) | | | 1 | 0.2 | 5 | 1 | 0.33 | 3 | 1 |
| | (a)/(b) (mass ratio) | | | 0.6 | 0.2 | 1 | 0.4 | 0.2 | 0.6 | 1.5 |
| | (a) + (c1) (mass %) | | | 6 | 6 | 6 | 4 | 4 | 4 | 15 |
| | pH of raw solution (25° C.) | | | 7.5 | 7.5 | 7.5 | 7.5 | 7.5 | 7.5 | 7.5 |
| | pH of diluted product with water | | | 7.5 | 7.5 | 7.5 | 7.5 | 7.5 | 7.5 | 7.5 |
| | at 0.2 mass % (25° C.) | | | | | | | | | |
| | Oxidation-reduction potential | | | 50 | 50 | 50 | 50 | 50 | 50 | 50 |
| | of (a) or (a′) (mV) | | | | | | | | | |
| | | | | Formulation example a | | | | | | |
| | | | | 8a | 9a | 10a | 11a | 12a | 13a | 14a |
| Detergent | Formulation | (a) | Sodium sulfite | 5 | 5 | 5 | 5 | 5 | 5 | 5 |
| composition | (mass %) | (c1) | C10AS | 5 | 5 | 5 | 5 | 5 | 5 | 5 |
| for use in | | (b) | Citric acid | 8 | 5 | 3 | 1 | | | |
| automatic | | | Sodium polyacrylate | | | | | 5 | 3 | 1 |
| dishwasher | | (d) | secC12-14EO7PO8.5 | 3 | 3 | 3 | 3 | 3 | 3 | 3 |

| | | | | | | | |
|---|---|---|---|---|---|---|---|
| Water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| (a)/(c1) (mass ratio) | 1 | 1 | 1 | 1 | 1 | 1 | 1 |
| (a)/(b) (mass ratio) | 0.63 | 1 | 1.67 | 5 | 1 | 1.67 | 5 |
| (a) + (c1) (mass %) | 10 | 10 | 10 | 10 | 10 | 10 | 10 |
| pH of raw solution (25° C.) | 7.5 | 7.5 | 7.5 | 7.5 | 7.5 | 7.5 | 7.5 |
| pH of diluted product with water | 7.5 | 7.5 | 7.5 | 7.5 | 7.5 | 7.5 | 7.5 |
| at 0.2 mass % (25° C.) | | | | | | | |
| Oxidation-reduction potential | 50 | 50 | 50 | 50 | 50 | 50 | 50 |
| of (a) or (a′) (mV) | | | | | | | |

### Example b and Comparative Example b

The formulation components used in example b and comparative example b are listed collectively below.

<Component (b1)>
Citric acid: pK′Ca 3.4, manufactured by Showa Kako Corporation
Sodium polyacrylate: sodium polyacrylate, pK′Ca 4.2, molecular weight 17,000, “POIZ 530” manufactured by Kao Corporation
EDTA: ethylenediaminetetraacetic acid, pK′Ca 6.0, manufactured by Tokyo Chemical Industry Co., Ltd.
   <Component (b1′) (Comparative Component for Component (b1))>
ASDA: L-asparagine-N, N-diacetic acid, pK′Ca 2.5, manufactured by NITTO CHEMICAL INDUSTRY CO., LTD.

A conditional calcium stability constant pK′Ca of component (b1) or (b1′) at a pH of 7.5 and 60° ° C. was measured in the same manner as in the method for measuring a conditional calcium stability constant pK′Ca of component (b) at a pH of 7.5 and 60° C. described in example a and comparative example a except that component (b) was substituted with component (b1) or (b1′).

<Component (a)>
Sodium sulfite: oxidation-reduction potential 50 mV, manufactured by FUJIFILM Wako Pure Chemical Corporation
Sodium disulfate: oxidation-reduction potential 17 mV, manufactured by FUJIFILM Wako Pure Chemical Corporation
Sodium thiosulfate: oxidation-reduction potential 5 mV, manufactured by FUJIFILM Wako Pure Chemical Corporation
Potassium iodide: oxidation-reduction potential 28 mV, manufactured by FUJIFILM Wako Pure Chemical Corporation
   <Component (a′) (Comparative Component for Component (a))>
Sodium dithionite: oxidation-reduction potential 76 mV, manufactured by FUJIFILM Wako Pure Chemical Corporation
Thiourea dioxide: oxidation-reduction potential 147 mV, manufactured by FUJIFILM Wako Pure Chemical Corporation

An oxidation-reduction potential of component (a) or (a′) was measured in the same manner as in the method for measuring an oxidation-reduction potential of component (a) or (a′) described in example a and comparative example a.

<Component (d)>
secC12-14E07PO8.5: “SOFTANOL EP7085” manufactured by NIPPON SHOKUBAI CO., LTD., a nonionic surfactant obtained by adding an average of 7 moles of ethylene oxide and an average of 8.5 moles of propylene oxide to a secondary alcohol with 12 to 14 carbons in this order
   <Component (c)>
C10AS: sodium decyl sulfate, “EMAL 3F” manufactured by Kao Corporation

Using the detergent compositions for use in an automatic dishwasher shown in Table 3, washing power for egg yolk soil was evaluated according to the procedures below. The results are shown in Table 3. Note that adjustments with sodium hydroxide and/or sulfuric acid were made as necessary to obtain the pH of the compositions in Table 3.
(1) The mass of a SUS stainless-steel tray (outer dimensions: width 258 mm×depth 177 mm×height 18 mm, inner dimensions of bottom: 235 mm×155 mm) (mass A) was measured.
(2) The stainless-steel tray was coated with 3 g of egg yolk and dried at room temperature for 3 hours or more.
(3) The mass of the stainless-steel tray after drying (mass B) was measured.
(4) Using JWE-400TA manufactured by HOSHIZAKI CORPORATION as a dishwasher, and each detergent composition for use in an automatic dishwasher in Table 1 diluted with water at 0.1 mass % as a washing liquid, the stainless-steel tray after drying was washed at a temperature of 60° C. for a period of time of 80 seconds at a flow rate of the washing liquid of 100 m/min, and a few seconds later, rinsing was carried out with rinsing water at 80° C. for 7 seconds at a flow rate of rinsing water of 1000 m/min. Note that part of the washing liquid was extracted and the pH at 25° C. was measured.
(5) The mass of the stainless-steel tray after washing (mass C) was measured, and the rate of mass change was evaluated as the egg yolk soil washing rate. The rate of mass change is specifically determined by the following formula:

Rate of mass change (%)={[B−C]/[B−A]}×100

TABLE 3

| | | | | Example b | | | | | | | | | |
|---|---|---|---|---|---|---|---|---|---|---|---|---|---|
| | | | | 1b | 2b | 3b | 4b | 5b | 6b | 7b | 8b | 9b | 10b |
| Detergent | Formulation | (b1) | Citric acid | 10 | 10 | 10 | | 5 | 5 | 11.8 | 4 | 5 | 10 |
| composition | (mass %) | | Sodium polyacrylate | | | | 10 | | | | | | |
| for use in | | | EDTA | | | | | 10 | | | | | |
| automatic | | (b1′) | ASDA | | | | | | | | | | |
| dishwasher | | (a) | Sodium sulfite | 5 | | | | 5 | 10 | 1.2 | 9 | 8 | 5 |
| | | | Sodium disulfate | | 5 | | | | | | | | |
| | | | Potassium iodide | | | 5 | | | | | | | |
| | | | Sodium thiosulfate | | | | 5 | | | | | | |
| | | (a′) | Sodium dithionite | | | | | | | | | | |
| | | | Thiourea dioxide | | | | | | | | | | |
| | | (d) | secC12-14EO7PO8.5 | 3 | 3 | 3 | 3 | 3 | | | | | |
| | | (c) | C10AS | 5 | 5 | 5 | 5 | 5 | 5 | | | | |

| Water | Bal- | Bal- | Bal- | Bal- | Bal- | Bal- | Bal- | Bal- | Bal- | Bal- |
|---|---|---|---|---|---|---|---|---|---|---|
| | ance | ance | ance | ance | ance | ance | ance | ance | ance | ance |
| Total | 100 | 100 | 100 | 100 | 100 | 100 | 100 | 100 | 100 | 100 |

| | | | | | | | | | | |
|---|---|---|---|---|---|---|---|---|---|---|
| (a)/(b1) (mass ratio) | 0.5 | 0.5 | 0.5 | 0.5 | 0.33 | 2 | 0.10 | 2.25 | 1.6 | 0.5 |
| (d)/(b1) (mass ratio) | 0.3 | 0.3 | 0.3 | 0.3 | 0.2 | — | — | — | — | — |
| (c)/(b1) (mass ratio) | 0.5 | 0.5 | 0.5 | 0.5 | 0.33 | 1 | — | — | — | — |
| pH of raw solution (25° C.) | 7.5 | 7.5 | 7.5 | 7.5 | 7.5 | 7.5 | 7.5 | 7.5 | 7.5 | 7.5 |
| pH of diluted product with water | 7.5 | 7.5 | 7.5 | 7.5 | 7.5 | 7.5 | 7.5 | 7.5 | 7.5 | 7.5 |
| at 0.1 mass % (25° C.) | | | | | | | | | | |
| pK′Ca of (b1) or (b1′) | 3.4 | 3.4 | 3.4 | 4.2 | 3.4 | 3.4 | 3.4 | 3.4 | 3.4 | 3.4 |
| | | | | | 6.0 | | | | | |
| Oxidation-reduction potential | 50 | 17 | 28 | 5 | 28 | 50 | 50 | 50 | 50 | 50 |
| of (a) or (a′) (mV) | | | | | | | | | | |

| | | | | | | | | | | |
|---|---|---|---|---|---|---|---|---|---|---|
| Egg yolk soil washing rate (%) | 100 | 99 | 94 | 100 | 100 | 100 | 90 | 100 | 100 | 90 |

| | | | | Example b | | | | | Comparative example b | | | |
|---|---|---|---|---|---|---|---|---|---|---|---|---|
| | | | | 11b | 12b | 13b | 14b | 15b | 1b | 2b | 3b | 4b |
| Detergent | Formulation | (b1) | Citric acid | 10 | 3.5 | 11 | 5 | 5 | 10 | 10 | | 5 |
| composition | (mass %) | | Sodium polyacrylate | | | | | | | | | |
| for use in | | | EDTA | | | | | | | | | |
| automatic | | (b1′) | ASDA | | | | | | | | 10 | |
| dishwasher | | (a) | Sodium sulfite | 3 | 9.5 | 2 | 0.8 | 1 | | | 5 | 0.5 |
| | | | Sodium disulfate | | | | | | | | | |
| | | | Potassium iodide | | | | | | | | | |
| | | | Sodium thiosulfate | | | | | | | | | |
| | | (a′) | Sodium dithionite | | | | | | 5 | | | |
| | | | Thiourea dioxide | | | | | | | 5 | | |
| | | (d) | secC12-14EO7PO8.5 | | | | | | 3 | 3 | 1 | |
| | | (c) | C10AS | | | | 5 | 5 | 5 | 5 | | 5 |

| Water | Bal- | Bal- | Bal- | Bal- | Bal- | Bal- | Bal- | Bal- | Bal- |
|---|---|---|---|---|---|---|---|---|---|
| | ance | ance | ance | ance | ance | ance | ance | ance | ance |
| Total | 100 | 100 | 100 | 100 | 100 | 100 | 100 | 100 | 100 |

| | | | | | | | | | |
|---|---|---|---|---|---|---|---|---|---|
| (a)/(b1) (mass ratio) | 0.3 | 2.71 | 0.18 | 0.16 | 0.20 | 0 | 0 | — | 0.1 |
| (d)/(b1) (mass ratio) | — | — | — | — | — | 0.3 | 0.3 | — | — |
| (c)/(b1) (mass ratio) | — | — | — | 1 | 1 | 0.5 | 0.5 | — | 1 |
| pH of raw solution (25° C.) | 7.5 | 7.5 | 7.5 | 7.5 | 7.5 | 7.5 | 7.5 | 7.5 | 7.5 |
| pH of diluted product with water | 7.5 | 7.5 | 7.5 | 7.5 | 7.5 | 7.5 | 7.5 | 7.5 | 7.5 |
| at 0.1 mass % (25° C.) | | | | | | | | | |
| pK′Ca of (b1) or (b1′) | 3.4 | 3.4 | 3.4 | 3.4 | 3.4 | 3.4 | 3.4 | 2.5 | 3.4 |
| Oxidation-reduction potential | 50 | 50 | 50 | 50 | 50 | 76 | 147 | 50 | 50 |
| of (a) or (a′) (mV) | | | | | | | | | |

| | | | | | | | | | |
|---|---|---|---|---|---|---|---|---|---|
| Egg yolk soil washing rate (%) | 98 | 90 | 92 | 91 | 92 | 88 | 87 | 67 | 70 |

### Example c and Comparative Example c

The formulation components used in example c and comparative example c are listed collectively below.

<Component (a)>
Sodium sulfite: oxidation-reduction potential 50 mV, manufactured by FUJIFILM Wako Pure Chemical Corporation
Potassium iodide: oxidation-reduction potential 28 mV, manufactured by FUJIFILM Wako Pure Chemical Corporation
Sodium thiosulfate: oxidation-reduction potential 5 mV, manufactured by FUJIFILM Wako Pure Chemical Corporation
   <Component (a′) (Comparative Component for Component (a))>
Sodium dithionite: oxidation-reduction potential 76 mV, manufactured by FUJIFILM Wako Pure Chemical Corporation

An oxidation-reduction potential of component (a) or (a′) was measured in the same manner as in the method for measuring an oxidation-reduction potential of component (a) or (a′) described in example a and comparative example a.

<Component (e)>
KOH: potassium hydroxide, manufactured by FUJIFILM Wako Pure Chemical Corporation
NaOH: sodium hydroxide, manufactured by FUJIFILM Wako Pure Chemical Corporation
   <Component (f)>
Monoethanolamine: monoethanolamine, manufactured by Mitsui Chemicals, Inc.
potassium silicate: Choline S-458-K (aqueous potassium silicate solution), manufactured by KOEI CHEMICAL CO., LTD.
Sodium carbonate: sodium carbonate, manufactured by FUJIFILM Wako Pure Chemical Corporation
   <Component (b)>
Citric acid (sodium salt): sodium citrate, pKCa 3.4, manufactured by Showa Kako Corporation
MGDA (sodium salt): sodium salt of methylglycinediacetic acid, TRILON M LIQUID-JP, pKCa 6.3, manufactured by BASF SE
Polyacrylic acid (sodium salt): sodium polyacrylate, POIZ 530, pKCa 3.2, molecular weight 17,000, manufactured by Kao Corporation

A calcium stability constant pKCa of component (b) at a pH of 11 and 25° C. was measured by the method below.

A calcium chloride solution at 25° C. and 2 g/L was added dropwise into 100 mL of distilled water at 25° C. by an amount of 0.2 mL, the potential at that time was measured with a calcium ion-selective electrode manufactured by HORIBA, Ltd., and the equation for the first-order approximation was obtained with the logarithm of the calcium ion concentration for each dropwise-addition amount as the horizontal axis and the potential as the vertical axis. Subsequently, distilled water was added to component (d) such that the concentration was conditioned to 1 g/L, and the pH was adjusted to 11 with 1N sodium hydroxide and/or 1N hydrochloric acid, thereby preparing a chelating agent solution. 100 mL of the chelating agent solution was taken out and conditioned to 25° C., 3 mL of a calcium chloride solution at 25° C. and 2 g/L was added dropwise thereto, and the potential was measured with a calcium ion-selective electrode manufactured by HORIBA, Ltd. The potential at that time was substituted into the approximation equation to determine concentration A of uncaptured calcium in the chelating agent solution (mol/L), and it was substituted into the formula below together with concentration B of the chelating agent (mol/L), thereby determining KCa to give the logarithm as pKCa.

KCa=(5.4×10⁻⁵−A)/(A×(B−(5.4×10⁻⁵−A)))

<Component (g)>
EP7085: secc12-14EO (7) PO (8.5), “SOFTANOL EP7085,” manufactured by NIPPON SHOKUBAI CO., LTD., a nonionic surfactant obtained by adding an average of 7 moles of ethylene oxide and an average of 8.5 moles of propylene oxide to a secondary alcohol with 12 to 14 carbons in this order
LS106: C12-14EO(3) PO(1.5) EO(4), EMULGEN LS 106, manufactured by Kao Corporation, a nonionic surfactant obtained by adding an average of 3 moles of ethylene oxide, an average of 1.5 moles of propylene oxide and an average of 3 moles of ethylene oxide to a primary alcohol with 12 to 14 carbons in this order

### <Another Component>

C8COONa: Sodium caprylate, LUNAC 8-98 (E), manufactured by Kao Corporation

Using the detergent compositions for use in an automatic dishwasher shown in Tables 4 and 5, washing power for heat-denatured egg yolk soil was evaluated according to the procedures below. The results are shown in Tables 4 and 5. Note that adjustments with sodium hydroxide and/or sulfuric acid were made as necessary to obtain the pH of the compositions in Tables 4 and 5.
(1) The mass of a ceramic round dish (diameter 235 mm, diameter of concave portion 140 mm) (mass A) was measured.
(2) 3 g of egg yolk was applied to the concave portion of the round dish and dried at 80° C. for 30 minutes to prepare heat-denatured egg yolk soil.
(3) The mass of the round dish after drying (mass B) was measured.
(4) Each detergent composition for use in an automatic dishwasher in Tables 4 and 5 was diluted with water at 0.1 mass % to prepare a washing liquid, and the pH at 25° C. was measured.
(5) Using JWE-680A manufactured by HOSHIZAKI CORPORATION as a dishwasher and the prepared washing liquid, the round dish was washed at a temperature of 60° C. for a period of time of 40 seconds at a flow rate of the washing liquid of 200 m/min, and a few seconds later, rinsing was carried out with fresh water at 80° ° C. for 6 seconds at a flow rate of rinsing water of 1000 m/min.
(6) The mass of the round dish after washing (mass C) was measured, and the rate of mass change was evaluated as the heat-denatured egg yolk soil washing rate. The rate of mass change is specifically determined by the following formula:

Rate of mass change (%)={[B−C]/[B−A]}×100
(7) Model soil (1N acetic acid) was added to a washing liquid prepared by diluting each detergent composition for use in an automatic dishwasher in Tables 4 and 5 with water at 0.1 mass % such that the added amount thereof was as shown in Table 4 or 5 and stirred to prepare a washing liquid mixed with soil, and the pH at 25° C. was measured.
(8) (5) and (6) above were carried out with the prepared washing liquid mixed with soil, and the rate of mass change was determined and evaluated as the heat-denatured egg yolk soil washing rate.

TABLE 4

| | | | | | Comparative |
|---|---|---|---|---|---|
| | | | | Example 1c | example 1c |
| Detergent | Formulation | (a) | Sodium sulfite | 10 | |
| composition | (mass %) | | Potassium iodide | | |
| for use in | | | Sodium thiosulfate | | |
| automatic | | (a′) | Sodium dithionite | | |
| dishwasher | | (e) | KOH | 4.5 | 4.5 |
| | | | NaOH | | |
| | | (f) | Monoethanolamine | | |
| | | | Sodium silicate | | |
| | | | Sodium carbonate | | |
| | | (b) | Citric acid (sodium salt) | 5 | 5 |
| | | | MGDA (sodium salt) | | |
| | | | Polyacrylic acid (sodium salt) | | |
| | | (g) | EP7085 | | |
| | | | LS106 | | |

| | | |
|---|---|---|
| C8COONa | | |
| Water | Balance | Balance |
| Total | 100 | 100 |

| | | | |
|---|---|---|---|
| | (a)/(e) (mass ratio) | 2.2 | 0 |
| | pH of raw solution (25° C.) | 13.9 | 13.9 |
| Initial | pH (25° C.) | 10.5 | 10.5 |
| | Heat-denatured egg yolk soil | 79 | 75 |
| | washing rate (%) | | |
| 10 g of | pH (25° C.) | 10.16 | 10.22 |
| soil | Heat-denatured egg yolk soil | 54 | 57 |
| | washing rate (%) | | |
| 20 g of | pH (25° C.) | 9.6 | 9.6 |
| soil | Heat-denatured egg yolk soil | 54 | 37 |
| | washing rate (%) | | |
| 30 g of | pH (25° C.) | 8.9 | 8.9 |
| soil | Heat-denatured egg yolk soil | 41 | 19 |
| | washing rate (%) | | |

| | | |
|---|---|---|
| 30 g of soil washing rate/ | 0.52 | 0.25 |
| initial washing rate | | |

TABLE 5

| | | | | Example c | | | | | | | |
|---|---|---|---|---|---|---|---|---|---|---|---|
| | | | | 2c | 3c | 4c | 5c | 6c | 7c | 8c | 9c |
| Detergent | Formulation | (a) | Sodium sulfite | 10 | | | 10 | 10 | 5 | 10 | 10 |
| composition | (mass %) | | Potassium iodide | | | 10 | | | | | |
| for use in | | | Sodium thiosulfate | | 10 | | | | | | |
| automatic | | (a′) | Sodium dithionite | | | | | | | | |
| dishwasher | | (e) | KOH | | | 4.5 | 4.5 | 3.5 | 4.5 | 2.5 | 4.5 |
| | | | NaOH | 4.5 | 4.5 | | | | | | |
| | | (f) | Monoethanolamine | | | | | | | | 2 |
| | | | Sodium silicate | | | | | | | | |
| | | | Sodium carbonate | | | | | | | | |
| | | (b) | Citric acid | 5 | 5 | 5 | | 5 | 5 | 5 | 5 |
| | | | (sodium salt) | | | | | | | | |
| | | | MGDA | | | | | | | | |
| | | | (sodium salt) | | | | | | | | |
| | | | Polyacrylic acid | | | | | | | | |
| | | | (sodium salt) | | | | | | | | |
| | | (g) | EP7085 | | | | | | | | |
| | | | LS106 | | | | | | | | |
| | | C8COONa | | | | | | | | | |
| | | Water | | Balance | Balance | Balance | Balance | Balance | Balance | Balance | Balance |
| | | Total | | 100 | 100 | 100 | 100 | 100 | 100 | 100 | 100 |
| | (a)/(e) (mass ratio) | | | 2.2 | 2.2 | 2.2 | 2.2 | 2.9 | 1.1 | 4 | 2.2 |
| | pH of raw solution (25° C.) | | | 13.9 | 13.9 | 13.9 | 13.9 | 13.8 | 13.9 | 13.7 | 13.9 |
| Initial | pH (25° C.) | | | 10.5 | 10.6 | 10.5 | 10.5 | 10.3 | 10.5 | 9.8 | 10.5 |
| | Heat-denatured egg yolk soil washing rate (%) | | | 91 | 83 | 56 | 75 | 74 | 68 | 68 | 88 |
| 30 g of soil | pH (25° C.) | | | 9.8 | 9.8 | 9.2 | 9.1 | 8.6 | 9.1 | 8.0 | 9.5 |
| | Heat-denatured egg yolk soil washing rate (%) | | | 44 | 43 | 23 | 34 | 42 | 46 | 31 | 62 |
| 30 g of soil washing rate/initial washing rate | | | | 0.48 | 0.52 | 0.42 | 0.45 | 0.56 | 0.67 | 0.45 | 0.71 |
| | | | | | | | | | | Comparative | |
| | | | | Example c | | | | | | example c | |
| | | | | 10c | 11c | 12c | 13c | 14c | 15c | 2c | 3c |
| Detergent | Formulation | (a) | Sodium sulfite | 10 | 10 | 10 | 10 | 10 | 10 | 10 | |
| composition | (mass %) | | Potassium iodide | | | | | | | | |
| for use in | | | Sodium thiosulfate | | | | | | | | |
| automatic | | (a′) | Sodium dithionite | | | | | | | | 10 |
| dishwasher | | (e) | KOH | 4.5 | 4.5 | 4.5 | 4.5 | 4.5 | 4.5 | | 4.5 |
| | | | NaOH | | | | | | | | |
| | | (f) | Monoethanolamine | | | 6 | | | 2 | | |
| | | | Sodium silicate | 2 | | | | | | | |
| | | | Sodium carbonate | | 2 | | | | | | |
| | | (b) | Citric acid | 5 | 5 | 5 | | | 2 | 5 | 5 |
| | | | (sodium salt) | | | | | | | | |
| | | | MGDA | | | | 5 | | 2 | | |
| | | | (sodium salt) | | | | | | | | |
| | | | Polyacrylic acid | | | | | 5 | 1 | | |
| | | | (sodium salt) | | | | | | | | |
| | | (g) | EP7085 | | | | | | 2 | | |
| | | | LS106 | | | | | | 0.1 | | |

| | | | | | | | | |
|---|---|---|---|---|---|---|---|---|
| C8COONa | | | | | | 2 | | |
| Water | Balance | Balance | Balance | Balance | Balance | Balance | Balance | Balance |
| Total | 100 | 100 | 100 | 100 | 100 | 100 | 100 | 100 |

| | | | | | | | | | |
|---|---|---|---|---|---|---|---|---|---|
| | (a)/(e) (mass ratio) | 2.2 | 2.2 | 2.2 | 2.2 | 2.2 | 2.2 | — | 0 |
| | pH of raw solution (25° C.) | 13.9 | 13.9 | 13.9 | 13.9 | 13.9 | 13.9 | 9.9 | 13.9 |
| Initial | pH (25° C.) | 10.7 | 10.7 | 10.6 | 10.5 | 10.55 | 10.48 | 8.8 | 10.2 |
| | Heat-denatured egg yolk soil washing rate (%) | 86 | 87 | 94 | 78 | 82 | 87 | 32 | 53 |
| 30 g of soil | pH (25° C.) | 9.8 | 9.8 | 9.8 | 9.36 | 9.55 | 9.53 | 7.5 | 8.2 |
| | Heat-denatured egg yolk soil washing rate (%) | 66 | 58 | 85 | 52 | 39 | 61 | 7 | 16 |

| | | | | | | | | |
|---|---|---|---|---|---|---|---|---|
| 30 g of soil washing rate/initial washing rate | 0.77 | 0.66 | 0.91 | 0.67 | 0.48 | 0.69 | 0.22 | 0.31 |

### Example d and Comparative Example d

The formulation components used in example d and comparative example d are listed collectively below.

<Component (a)>
Sodium sulfite: oxidation-reduction potential 50 mV, manufactured by FUJIFILM Wako Pure Chemical Corporation
Sodium disulfate: oxidation-reduction potential 17 mV, manufactured by FUJIFILM Wako Pure Chemical Corporation
Potassium iodide: oxidation-reduction potential 28 mV, manufactured by FUJIFILM Wako Pure Chemical Corporation
   <Component (a′) (Comparative Component for Component (a))>
Sodium dithionite: oxidation-reduction potential 76 mV, manufactured by FUJIFILM Wako Pure Chemical Corporation
Thiourea dioxide: oxidation-reduction potential 147 mV, manufactured by FUJIFILM Wako Pure Chemical Corporation

An oxidation-reduction potential of component (a) or (a′) was measured in the same manner as in the method for measuring an oxidation-reduction potential of component (a) or (a′) described in example a and comparative example a.

<Component (b)>
Citric acid: pK′Ca 3.4, manufactured by Showa Kako Corporation

A conditional calcium stability constant pK′Ca of component (b) at a pH of 7.5 and 60° C. was measured in the same manner as in the method for measuring a conditional calcium stability constant pK′Ca of component (b) at a pH of 7.5 and 60° ° C. described in example a and comparative example a.

<Component (c)>
C10AS: sodium decyl sulfate, “EMAL 3F” manufactured by Kao Corporation
   <Component (d)>
secC12-14E07PO8.5: “SOFTANOL EP7085” manufactured by NIPPON SHOKUBAI CO., LTD., a nonionic surfactant obtained by adding an average of 7 moles of ethylene oxide and an average of 8.5 moles of propylene oxide to a secondary alcohol with 12 to 14 carbons in this order

### [Measurement of Disulfide Bond Cleavage Rate]

According to the procedures below, the disulfide bond cleavage rate by an agent for cleaving disulfide bonds for egg yolk soil was measured.

4-(Aminosulfonyl)-7-fluoro-2,1,3-benzoxadiazole (ABD-F) manufactured by Tokyo Chemical Industry Co., Ltd. was added to a 0.1 M borate buffer at a pH of 8 to prepare a 100 UM ABD-F solution (hereinafter referred to as liquid (A)). Disodium ethylenediaminetetraacetate (EDTA2Na) was added to a 0.1 M borate buffer at a pH of 8 to prepare a 1 mM EDTA2Na solution, into which egg yolk, soil containing protein having disulfide bonds, was added at 1000 ppm, and component (a) or (a′) as an agent for cleaving disulfide bonds was added such that it was in an amount twice the concentration in the washing liquid of the present invention in the washing power evaluation described later to prepare liquid (B). Liquids (A) and (B) were placed in an Eppendorf tube in an amount of 500 μL each and mixed together. The mixed liquid was heated with a block heater manufactured by ATTO CORPORATION (WSC-2620) at 50° ° C. for 5 minutes, and then cooled with ice water for 10 minutes. After cooling, 300 μL of 0.1 M hydrochloric acid was added to the mixed liquid. 200 μL of the mixed liquid was placed in a 96-well plate and subjected to fluorometric measurements with SH-9000 manufactured by Corona Electric Co., Ltd. (excitation wavelength/measurement wavelength=389/513 nm, measurement sensitivity×100).

Next, egg yolk, soil containing protein having disulfide bonds, was added at 1000 ppm to an aqueous NaOH solution whose pH was adjusted to 11 to prepare liquid (B), liquid (B) was mixed with the above liquid (A) to prepare a mixed liquid using NaOH as an agent for cleaving disulfide bonds, and fluorometric measurements were made in the same manner as above.

Next, liquid (B) was prepared in the same manner as above except that, during the preparation of liquid (B), glutathione (manufactured by FUJIFILM Wako Pure Chemical Corporation), a simple compound having disulfide bonds, was added at varying concentrations instead of egg yolk, and sodium sulfite was added at 1000 ppm as an agent for cleaving disulfide bonds, liquid (B) was mixed with the above liquid (A) to prepare mixed liquids at varying glutathione concentrations, fluorometric measurements were made in the same manner as above, and a calibrate curve of the glutathione concentration and the fluorescence intensity was prepared.

The amount of disulfide bonds cleaved by each agent for cleaving disulfide bonds was estimated from this calibration curve and the fluorometric measurement result for the soil containing protein having disulfide bonds when each agent for cleaving disulfide bonds was used, and with the fluorometric measurement result when NaOH was used as an agent for cleaving disulfide bonds as a disulfide bond cleavage rate of 100%, the disulfide bond cleavage rate by each agent for cleaving disulfide bonds was calculated.

Using the concentrated compositions shown in Tables 6 and 7, washing power for egg yolk soil was evaluated according to the procedures below. The results are shown in Tables 6 and 7. Note that adjustments with sodium hydroxide and/or sulfuric acid were made as necessary to obtain the pH of the compositions in Tables 6 and 7.

### [Washing Power Evaluation]

(1) The mass of a SUS stainless-steel tray (outer dimensions: width 258 mm×depth 177 mm×height 18 mm, inner dimensions of bottom: 235 mm×155 mm) (mass A) was measured.
(2) The stainless-steel tray was coated with 3 g of egg yolk and dried at room temperature for 3 hours or more. (3) The mass of the stainless-steel tray after drying (mass B) was measured.
(4) Using JWE-400TA manufactured by HOSHIZAKI CORPORATION as a dishwasher, and each concentrated composition in Tables 6 and 7 diluted with water at 0.2 mass % as a washing liquid, the stainless-steel tray after drying was washed for a period of time and at a temperature of the washing liquid shown in Table 6 or 7 at a flow rate of the washing liquid of 100 m/min, and a few seconds later, rinsing was carried out with rinsing water at 80° C. for 7 seconds at a flow rate of rinsing water of 1000 m/min. Note that part of the washing liquid was extracted and the pH at 25° C. was measured.
(5) The mass of the stainless-steel tray after washing (mass C) was measured, and the rate of mass change was evaluated as the egg yolk soil washing rate. The rate of mass change is specifically determined by the following formula:

Rate of mass change (%)={[B−C]/[B−A]}×100

TABLE 6

| | | | | | | | Comparative | | Reference |
|---|---|---|---|---|---|---|---|---|---|
| | | | | Example d | | | example d | | example d |
| | | | | 1d | 2d | 3d | 1d | 2d | 1d |
| Concentrated | Formulation | (a) | Sodium sulfite | 5 | | | | | |
| composition | (mass %) | | Sodium disulfate | | 5 | | | | |
| | | | Potassium iodide | | | 5 | | | |
| | | (a′) | Sodium dithionite | | | | 5 | | |
| | | | Thiourea dioxide | | | | | 5 | |
| | | (b) | Citric acid | 10 | 10 | 10 | 10 | 10 | 10 |
| | | (c) | C10AS | 5 | 5 | 5 | 5 | 5 | 5 |
| | | (d) | secC12-14EO7PO8.5 | 3 | 3 | 3 | 3 | 3 | 3 |

| | | | | | | |
|---|---|---|---|---|---|---|
| Sodium hydroxide | | | | | | 5.9 |
| Water | Balance | Balance | Balance | Balance | Balance | Balance |
| Total | 100 | 100 | 100 | 100 | 100 | 100 |

| | | | | | | |
|---|---|---|---|---|---|---|
| pH of washing liquid (25° C.) | 7.5 | 7.5 | 7.5 | 7.5 | 7.5 | 11.5 |
| Disulfide bond cleavage rate (%) | 41 | 75 | 29 | 0 | 4 | 100 |
| Washing time (second) | 80 | 80 | 80 | 80 | 80 | 80 |
| Temperature of washing liquid (° C.) | 60 | 60 | 60 | 60 | 60 | 60 |
| Egg yolk soil washing rate (%) | 100 | 99 | 94 | 88 | 87 | 100 |

TABLE 7

| | | | | Example d | | | |
|---|---|---|---|---|---|---|---|
| | | | | 4d | 5d | 6d | 7d |
| Concentrated | Formulation | (a) | Sodium sulfite | 5 | 5 | 5 | 5 |
| composition | (mass %) | | Sodium disulfate | | | | |
| | | | Potassium iodide | | | | |
| | | (a′) | Sodium dithionite | | | | |
| | | | Thiourea dioxide | | | | |
| | | (b) | Citric acid | 10 | 10 | 10 | 10 |
| | | (c) | C10AS | 5 | 5 | 5 | 5 |
| | | (d) | secC12-14EO7PO8.5 | 3 | 3 | 3 | 3 |

| | | | | |
|---|---|---|---|---|
| Sodium hydroxide | | | | |
| Water | Balance | Balance | Balance | Balance |
| Total | 100 | 100 | 100 | 100 |

| | | | | |
|---|---|---|---|---|
| pH of washing liquid (25° C.) | 7.5 | 7.5 | 7.5 | 7.5 |
| Disulfide bond cleavage rate (%) | 41 | 41 | 41 | 41 |
| Washing time (second) | 40 | 50 | 80 | 80 |
| Temperature of washing liquid (° C.) | 60 | 60 | 30 | 40 |
| Egg yolk soil washing rate (%) | 91 | 95 | 91 | 98 |

1. A detergent composition, comprising:
the following component (a);
the following component (c1); and
water,
component (a): a reducing agent with an oxidation-reduction potential of +71 mV or less, and
component (c1): a low-foaming anionic surfactant,
wherein the composition has a content of the component (a) of 3 mass % or more, a content of water of 20 mass % or more, and a pH of 6 or more and 11 or less at 25° C.

2. (canceled)

3. The detergent composition according to claim 1, wherein the component (a) is one or more selected from a sulfite, a disulfate, a thiosulfate and an iodide salt.

4-5. (canceled)

6. The detergent composition according to claim 1, wherein the component (c1) is one or more selected from an alkyl or alkenyl sulfate with 6 or more and 11 or less carbons, an alkyl or alkenyl sulfonic acid with 6 or more and 11 or less carbons and salts thereof.

7. The detergent composition according to claim 1, wherein a mass ratio of a content of the component (a) to a content of the component (c1), (a)/(c1), is 0.01 or more and 10 or less.

8. The detergent composition according to claim 1, further comprising the following component (b),
component (b): a chelating agent.

9. (canceled)

10. The detergent composition according to claim 8, wherein the component (b) is one or more selected from ethylenediaminetetraacetic acid, hexametaphosphoric acid, a polyacrylic acid, an acrylic acid-maleic acid copolymer, citric acid, tripolyphosphoric acid, nitrilotriacetic acid, glutamic diacetic acid and salts thereof.

11. The detergent composition according to claim 8, wherein a mass ratio of a content of the component (a) to a content of the component (b), (a)/(b), is 0.05 or more and 3 or less.

12. The detergent composition according to claim 1, further comprising the following component (d),
component (d): a nonionic surfactant.

13. A method for washing tableware comprising:
washing, by using an automatic dishwasher, tableware adhered with soil containing protein with a washing liquid prepared by diluting the detergent composition according to claim 1 with water.

14. The method for washing tableware according to claim 13, wherein the washing liquid is prepared by diluting the detergent composition with water by a factor of more than one and 2000 or less.

15. (canceled)

16. The method for washing tableware according to claim 13, wherein a temperature of the washing liquid is 30° C. or more and 90° C. or less.

17-70. (canceled)
